(19) United States
(12) Patent Application Publication
(10) Pub. No.: US 2012/0007844 A1
(43) Pub. Date: Jan. 12, 2012

(54) BACKLIGHT DEVICE AND DISPLAY APPARATUS

(75) Inventors: Hideyuki Nakanishi, Osaka (JP); Yoshio Umeda, Hyogo (JP); Toshiki Onishi, Osaka (JP); Takahiro Kobayashi, Osaka (JP); Seiji Hamada, Osaka (JP)

(73) Assignee: PANASONIC CORPORATION, Kadoma-shi, Osaka (JP)

(21) Appl. No.: 13/257,782

(22) PCT Filed: Sep. 28, 2010
(86) PCT No.: PCT/JP2010/005815

§ 371 Date: Sep. 20, 2011

(30) Foreign Application Priority Data
Sep. 30, 2009 (JP) 2009-227576

(51) Int. Cl. G09G 5/00

(52) U.S. Cl. 345/204

(57) ABSTRACT

Provided is a backlight device, wherein when the drive duty and drive current are controlled in each of predetermined light-emitting areas of a light-emitting unit, the color unevenness and moving image resolution difference between image display areas corresponding thereto are improved. A light-emitting unit (121) comprises a plurality of light-emitting areas. A motion amount detecting unit (131) detects the motion amount of an image in each of image display areas. A drive condition specifying unit specifies, with respect to each of the plurality of light-emitting areas, a drive condition including the duty and pulse height value of a drive pulse for causing each of the plurality of light-emitting areas to emit light, on the basis of the detected motion amount. An LED driver (123) drives each of the plurality of light-emitting areas on the specified drive condition. When a difference between the detected motion amounts occurs between adjacent image display areas, the drive condition specifying unit adjusts the drive conditions such that a difference between the drive conditions occurring between adjacent light-emitting areas is reduced according to the difference between the detected motion amounts.

### TECHNICAL FIELD

The present invention relates to a backlight apparatus and a display apparatus using a backlight apparatus.

### BACKGROUND ART

A non-self-luminous display apparatus, typified by a liquid crystal display apparatus, has a backlight apparatus (or hereinafter simply referred to as “backlight”) in the back. A display apparatus of this kind displays an image through an optical modulation section, which adjusts the amount of light which is reflected or which transmits, in the light emitted from the backlight, in accordance with image signals. Also, a display apparatus of this kind turns on and off a light source intermittently in synchronization with scanning of images, in order to improve the movie blur with a display apparatus of ahold type drive.

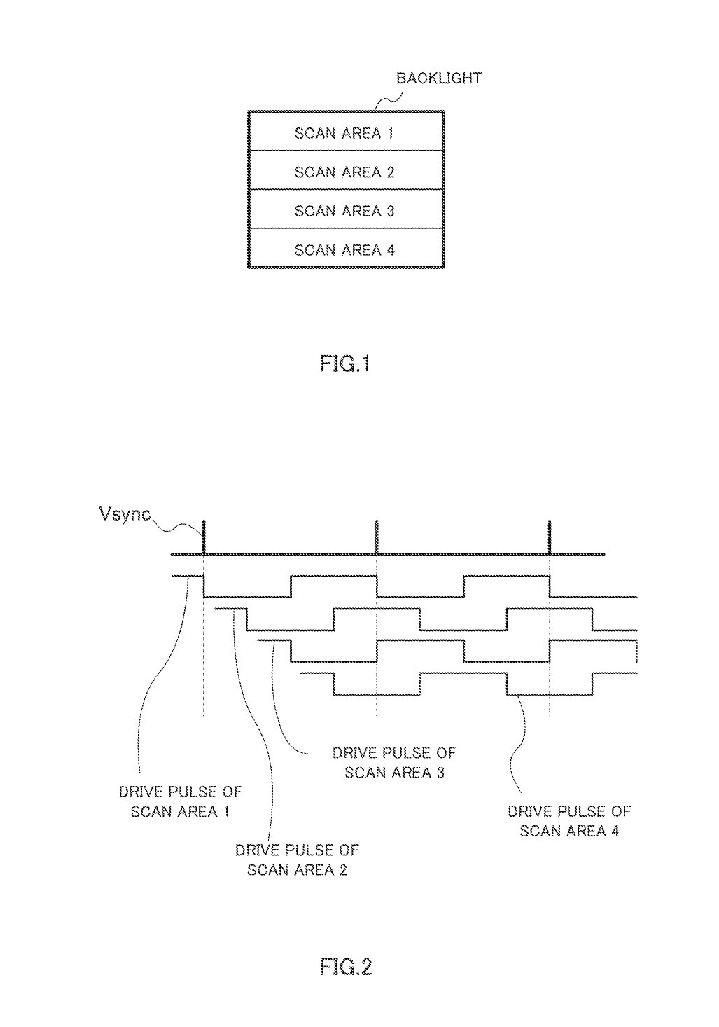

Generally, as examples of this intermittent lighting, there are a scheme of making an entire light emitting surface of a backlight flash with predetermined timing (which is generally referred to as “backlight blink”) and a scheme of dividing a light emitting surface of a backlight into a plurality of scan areas in vertical directions as shown in FIG. 1 and making the individual scan areas flash sequentially in synchronization with scanning of images (which is generally referred to as “backlight scan”).

For example, the liquid crystal display apparatus of the backlight blink scheme disclosed in patent literature 1 controls the drive duty (hereinafter also referred to as “duty”) and drive current (hereinafter also referred to as “peak value”) of a light source by determining whether an input image is a still image or a moving image.

For example, the liquid crystal display apparatus of the backlight scan scheme disclosed in patent literature 1 controls the drive duty of a light source in accordance with the scale of motion in an image.

### CITATION LIST

### Patent Literature

PTL 1
Japanese Patent Publication No. 3535799

PTL 2
Japanese Patent Application Laid-Open No. 2006-323300

### SUMMARY OF INVENTION

### Technical Problem

With the liquid crystal display apparatus disclosed in above patent literature 2, even when an input image is a movie, if the image in part of an image display area corresponding to part of scan areas is not moving, the drive duty in that scan area is not lowered and is maintained. That is to say, it is possible to prevent movie blur and improve movie resolution by not lowering the drive duty in part of scan areas and by lowering the drive duty only in the other scan areas.

In this case, in order to maintain the same brightness in all scan areas, although, on one hand, it is necessary to increase the drive current on a comparative scale in scan areas where the drive duty is lowered, on the other hand, it is possible to drive scan areas where the drive duty is not lowered by a low current of good light emission efficiency.

However, controlling the drive current in this way has a problem of providing an image in uneven color because neighboring scan areas are driven by different currents. This is because, when a light source is, for example, a light emitting diode (LED), the luminescent chromaticity (in other words, the luminescent wavelength) of the light source varies depending on the driving current.

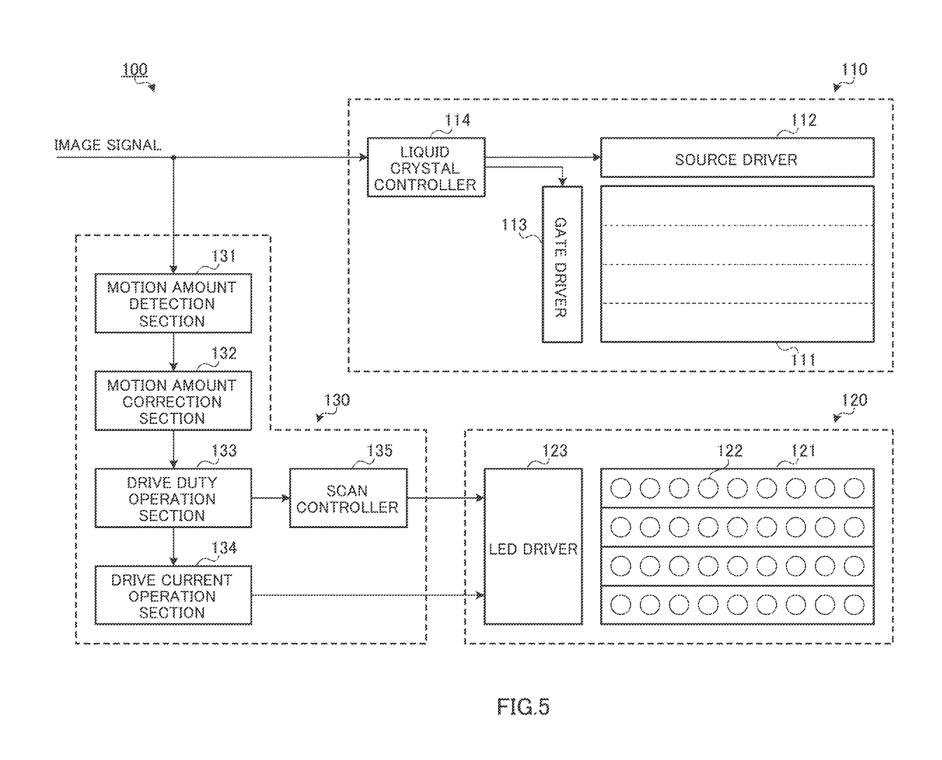

For example, as shown in FIG. 3, a case is assumed where a movie in which a vertical black line moves laterally on a white background is shown on a liquid crystal panel. In the example of FIG. 3, the partial images in image display area 1 and image display area 2 are still images, and therefore in image display areas 1 and 2, compared to the rest of image display areas 3 and 4, the drive current may be set low and the drive duty may be set high. In this case, the luminescent chromaticity varies significantly between image display areas 1 and 2 and image display areas 3 and 4, so that difference in chromaticity may be visible in a boundary part between image display area 2 and image display area 3.

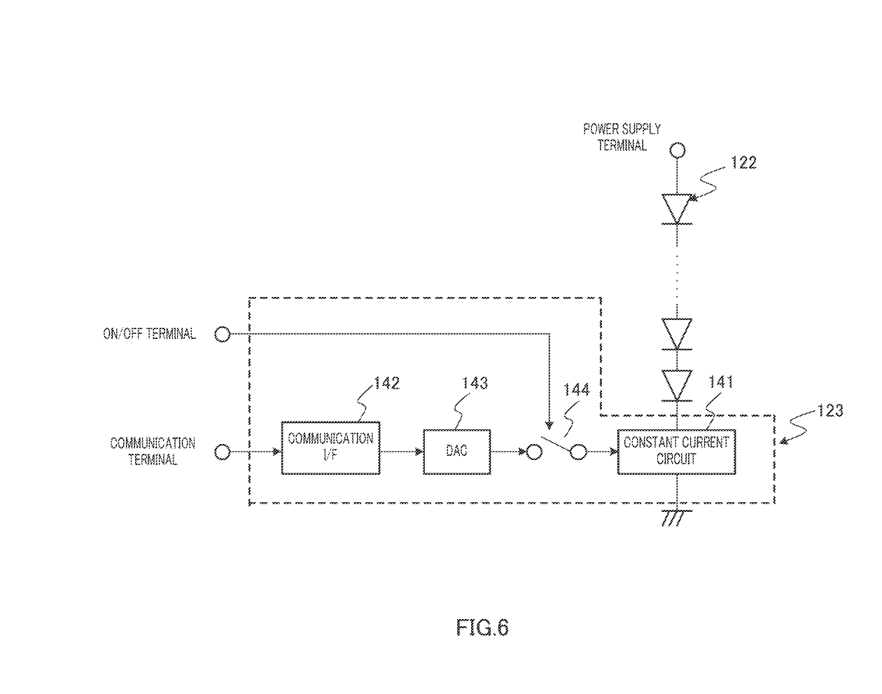

Furthermore, depending on the technique of motion detection in movie, other problems might occur. For example, as shown in FIG. 4, assume a case where, in the four black lines moving laterally at the same speed, only one of them bridges over image displays areas 1 to 4 and the other three stay in the range of image display areas 3 and 4. In this case, for example, if a motion detection method to simply calculate total difference from an image from one field earlier or an average value is used, or if a method to calculate a total vector magnitude or average value in micro area units is used, the amount of motion in image display areas 3 and 4 becomes significantly big compared to image display area 1 and 2. As a result of this, drive duty is decreased significantly in scan areas (scan areas 3 and 4 in the example of FIG. 1) emitting illuminating light to image display areas 3 and 4, but, in scan areas to emit illuminating light to image display areas 1 and 2 (scan areas 1 and 2 in the example of FIG. 1), drive duty cannot be lowered much, so that variation in movie resolution is produced.

It is therefore an object of the present invention to provide a backlight apparatus and display apparatus that can improve unevenness in color and variation of resolution in movie between corresponding image display areas in a case where drive duty and drive current are controlled per predetermined light emitting area in a light emitting section.

### Solution to Problem

The backlight apparatus according to the present invention has: a light emitting section that has a plurality of light emitting areas; a motion detection section that detects an amount of motion of an image in each of a plurality of image display areas corresponding to the plurality of light emitting areas; a drive condition designating section that designates drive conditions for allowing each of the plurality of light emitting areas to emit light, based on the amounts of motion detected, with respect to each of the plurality of light emitting areas, the drive conditions including drive pulse duties and peak values; and a drive section that drives each of the plurality of light emitting areas based on designated drive conditions, and, when differences are produced in the detected amounts of motion between neighboring image display areas, the drive condition designating section adjusts the drive conditions so that differences in drive conditions between neighboring light emitting areas are reduced in accordance with the differences between the detected amounts of motion.

The display apparatus of the present invention has: the above backlight apparatus; and an optical modulating section that displays an image in the plurality of image display areas by modulating illuminating light from the plurality of light emitting areas according to an image signal.

### Advantageous Effects of Invention

According to the present invention, when drive duty and drive current are controlled per predetermined light emitting area in a light emitting section, it is possible to improve unevenness in color and variation of resolution in movie between corresponding image display areas.

### DESCRIPTION OF EMBODIMENTS

FIG. 1 shows an example of a conventional scan area;

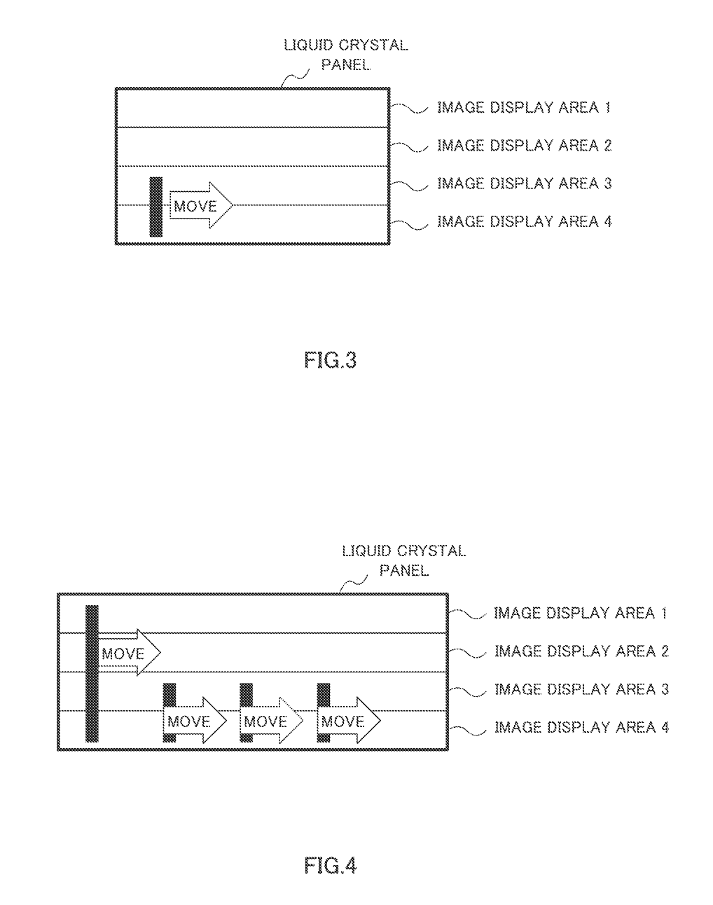

FIG. 2 shows a conventional backlight scanning method;

FIG. 3 shows an example of a movie displayed on a liquid crystal panel;

FIG. 4 shows another example of a movie displayed on a liquid crystal panel;

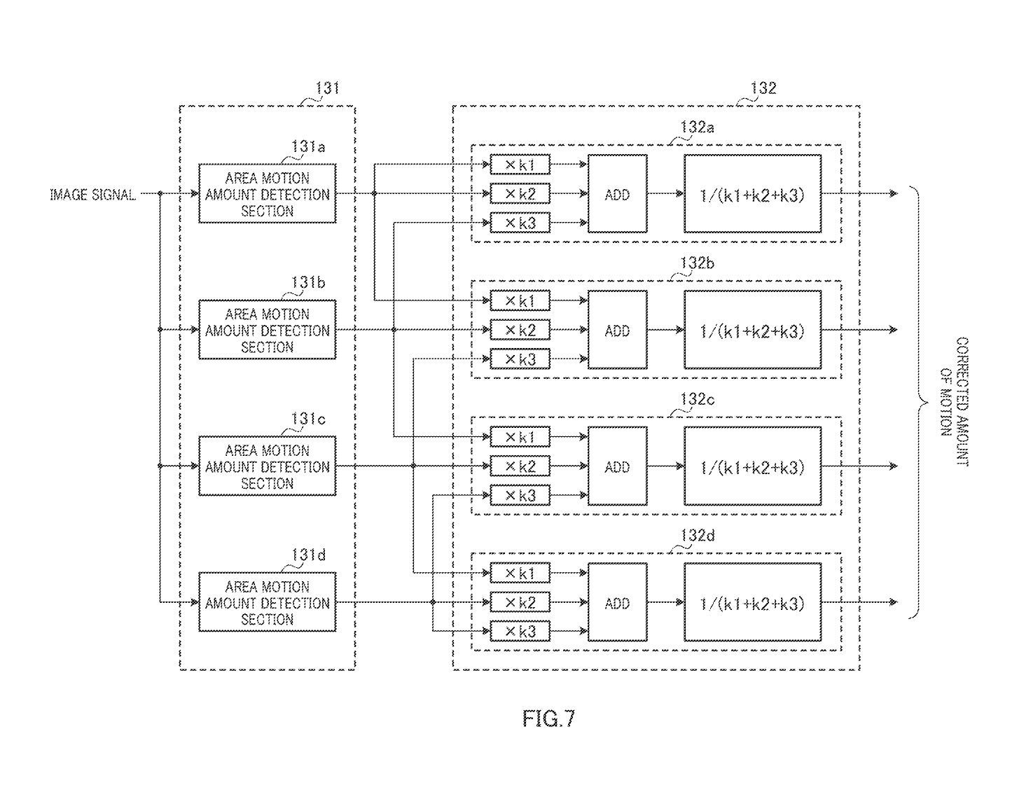

FIG. 5 is a block diagram showing a configuration of a liquid crystal display apparatus according to embodiment 1 of the present invention;

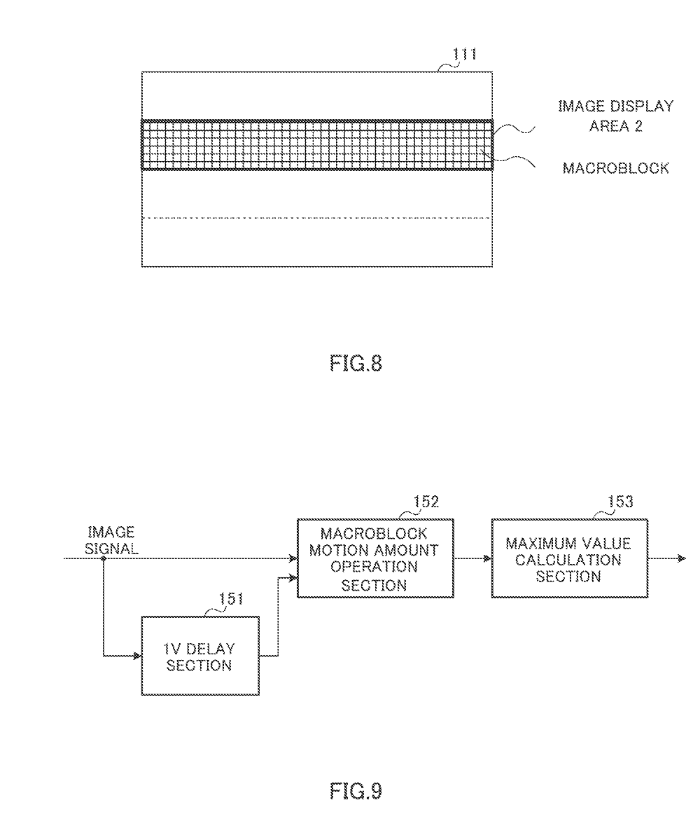

FIG. 6 is a block diagram showing a configuration of an LED driver according to embodiment 1 of the present invention;

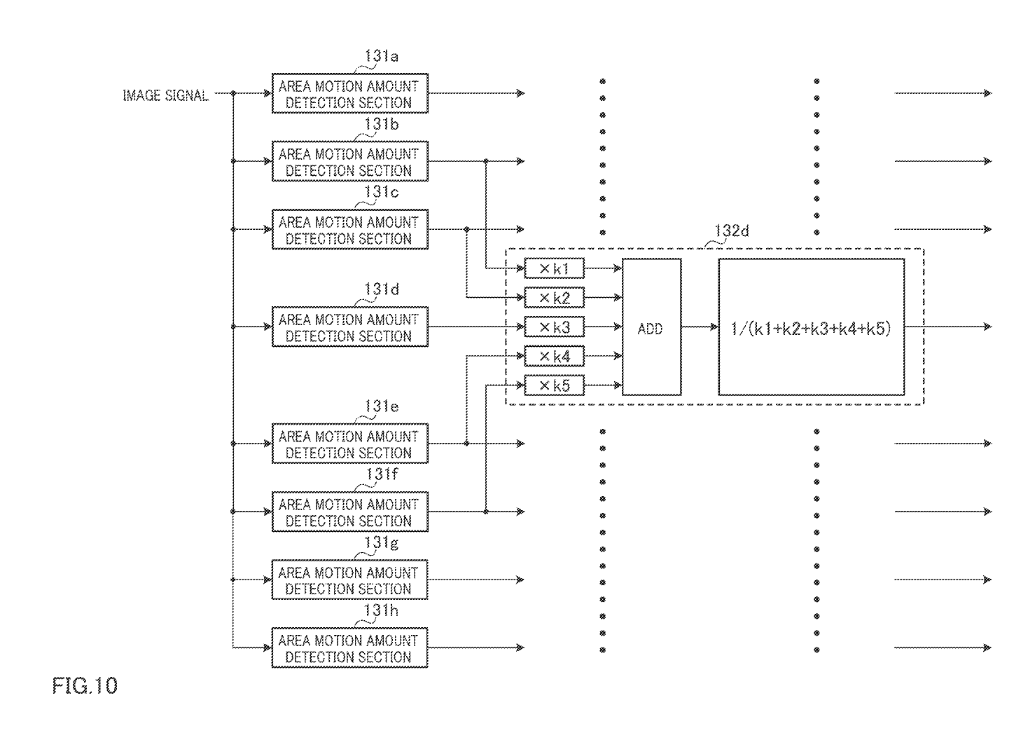

FIG. 7 is a block diagram showing a configuration of a motion amount detection section and motion amount correction section according to embodiment 1 of the present invention;

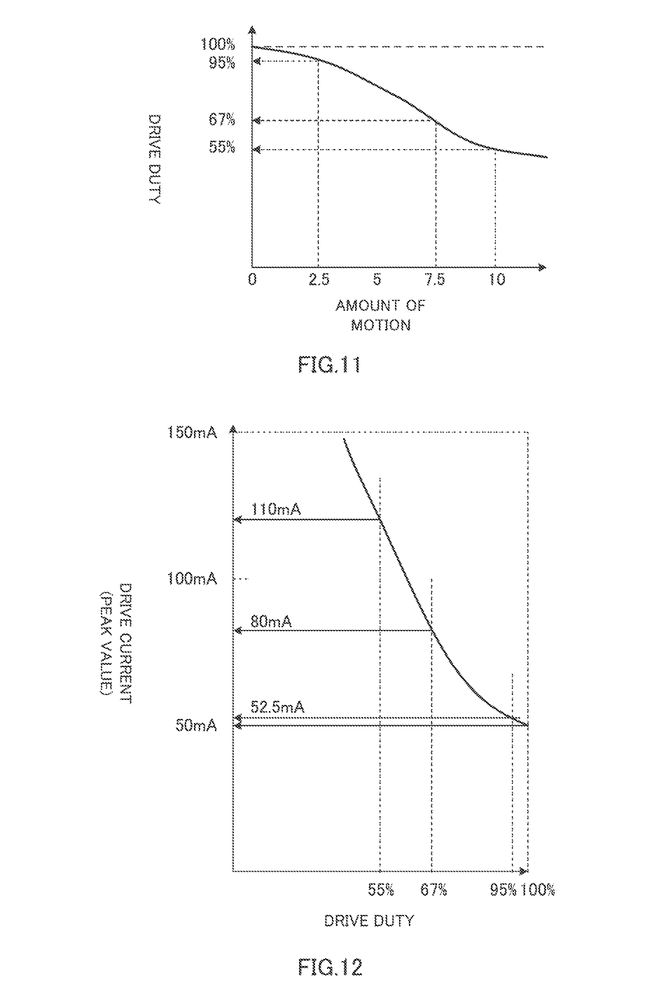

FIG. 8 shows a macroblock segmented from the image display area according to embodiment 1 of the present invention;

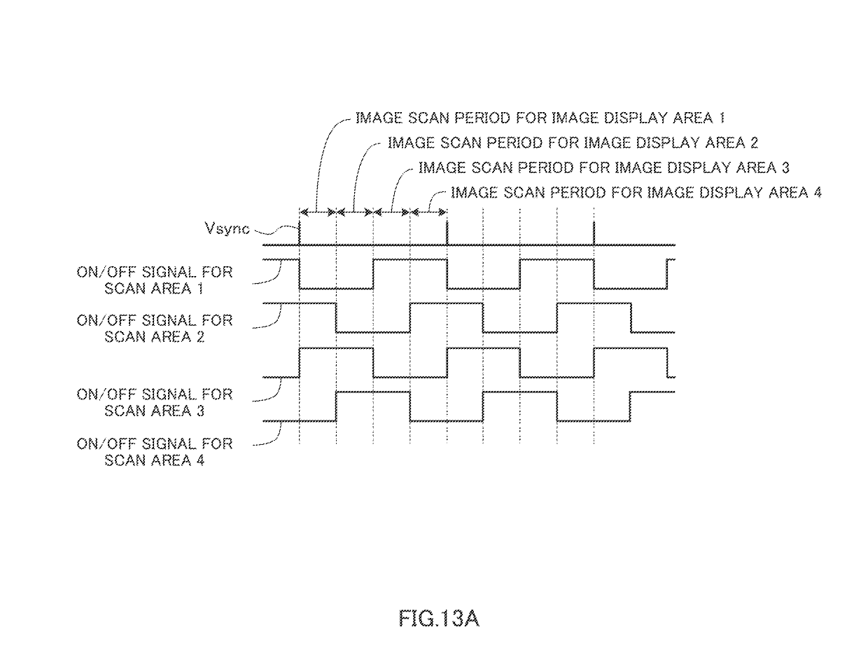

FIG. 9 is a block diagram showing a configuration of an area motion amount detection section according to embodiment 1 of the present invention;

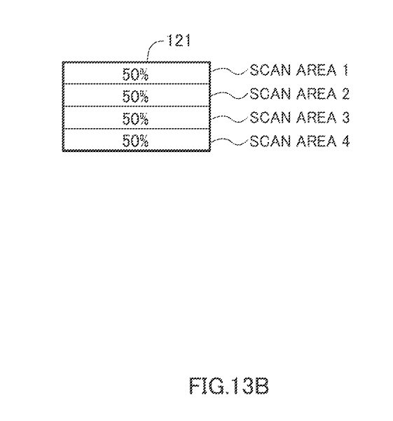

FIG. 10 is a block diagram showing a variation of a configuration of a motion amount correction section according to embodiment 1 of the present invention;

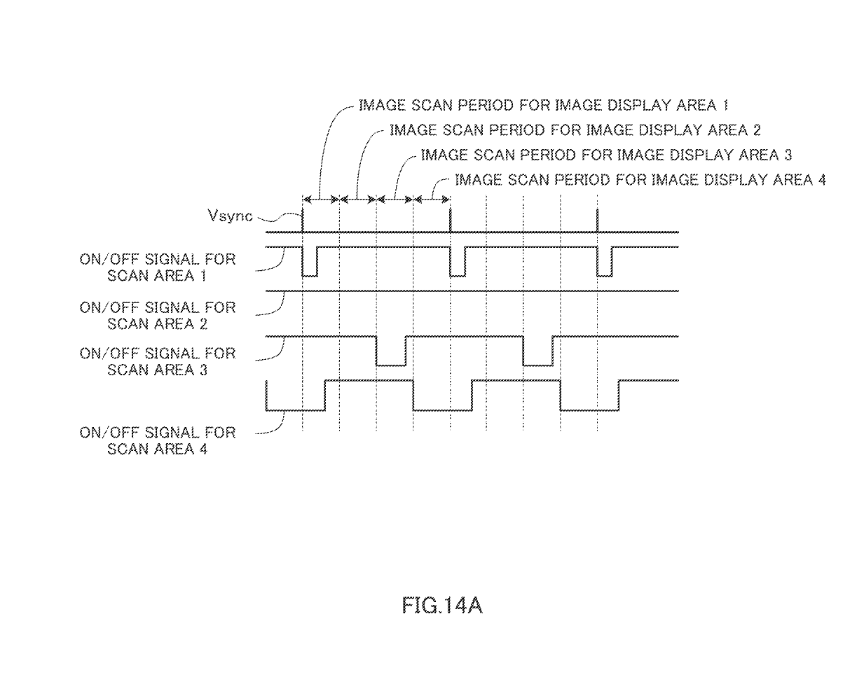

FIG. 11 shows a relationship between the amount of motion and drive duty according to embodiment 1 of the present invention;

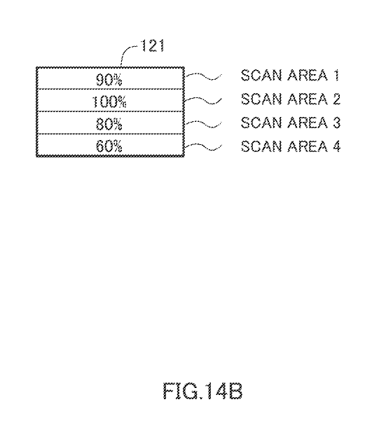

FIG. 12 shows a relationship between drive duty and drive current according to embodiment 1 of the present invention;

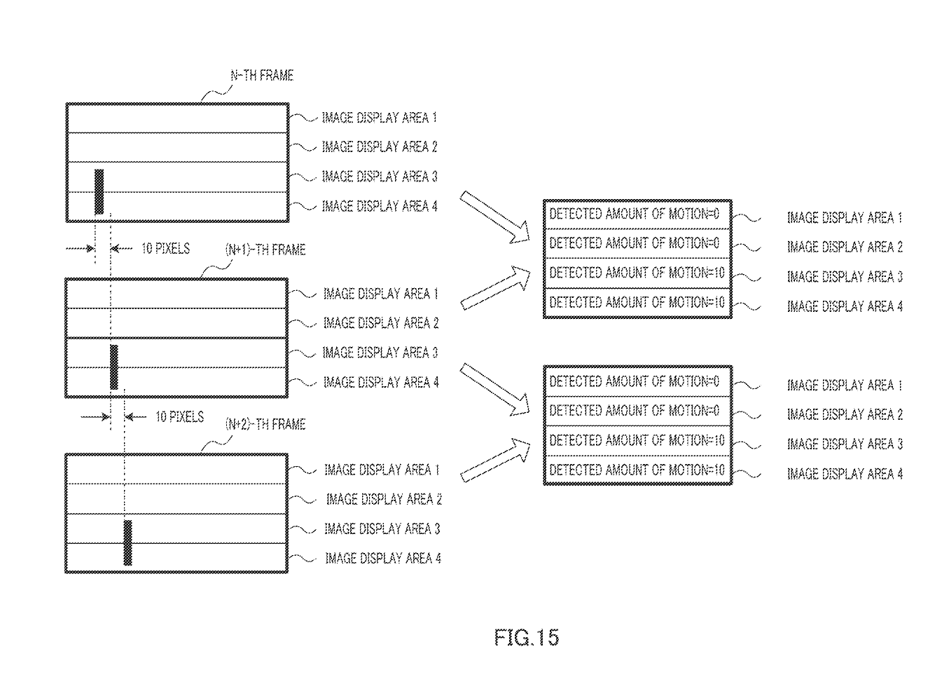

FIG. 13A shows examples of ON/OFF signal waveforms controlled by a scan controller according to embodiment 1 of the present invention;

FIG. 13B shows the duties of the ON/OFF signals shown in FIG. 13A;

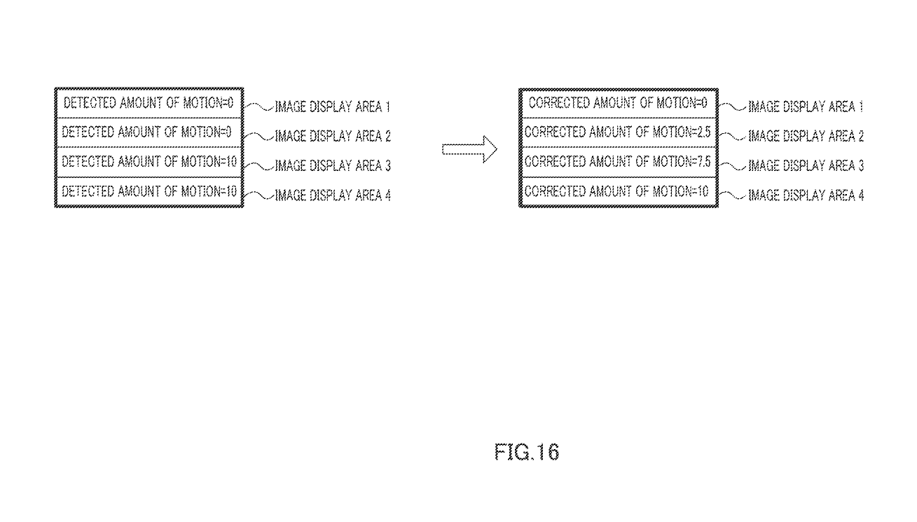

FIG. 14A shows other examples of ON/OFF signal waveforms controlled by a scan controller according to embodiment 1 of the present invention;

FIG. 14B shows the duties of the ON/OFF signals shown in FIG. 14A;

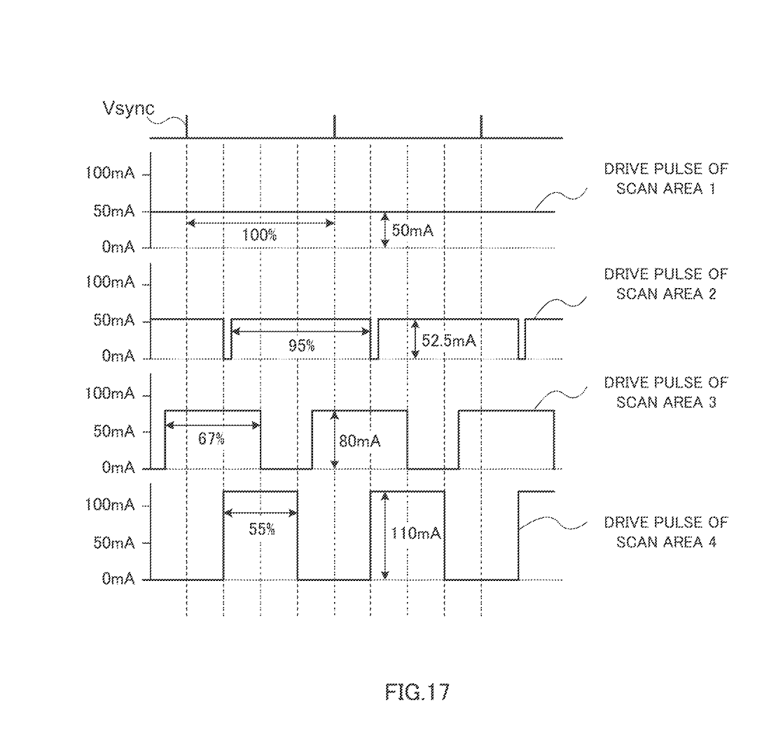

FIG. 15 shows an operation of motion amount detection per image display area according to embodiment 1 of the present invention;

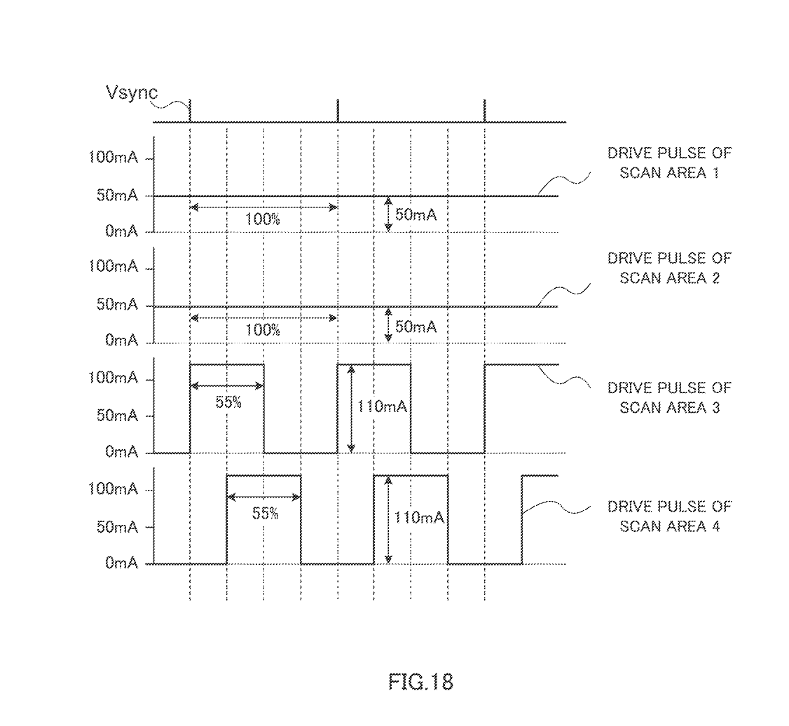

FIG. 16 shows an operation of motion amount correction per image display area according to embodiment 1 of the present invention;

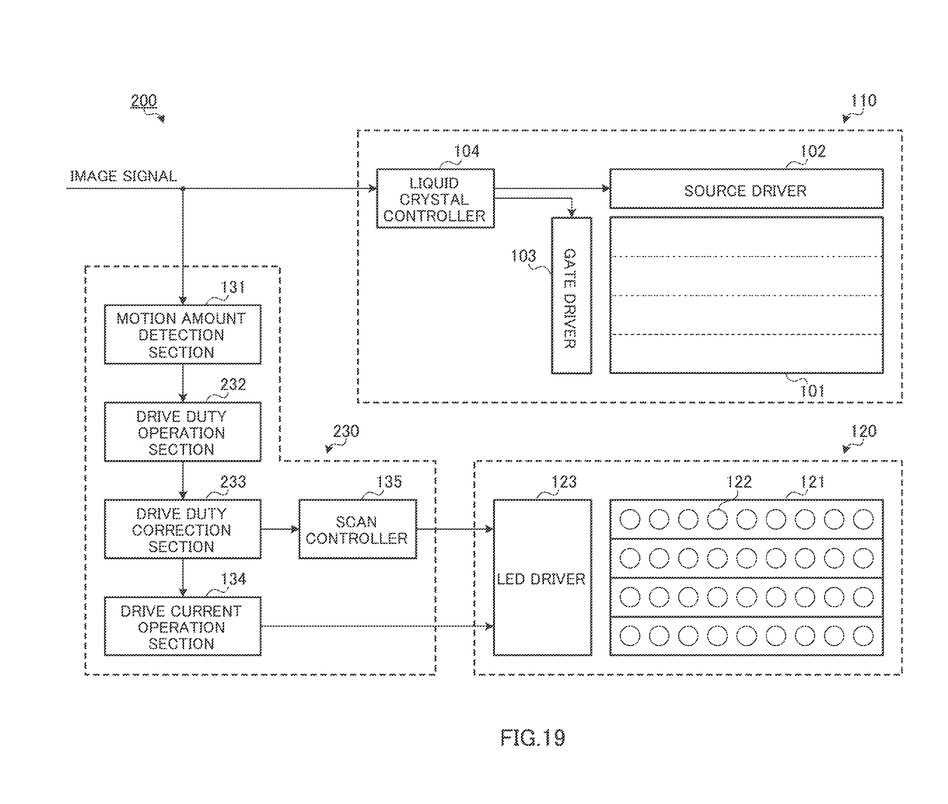

FIG. 17 shows examples of drive pulses per scan area according to embodiment 1 of the present invention;

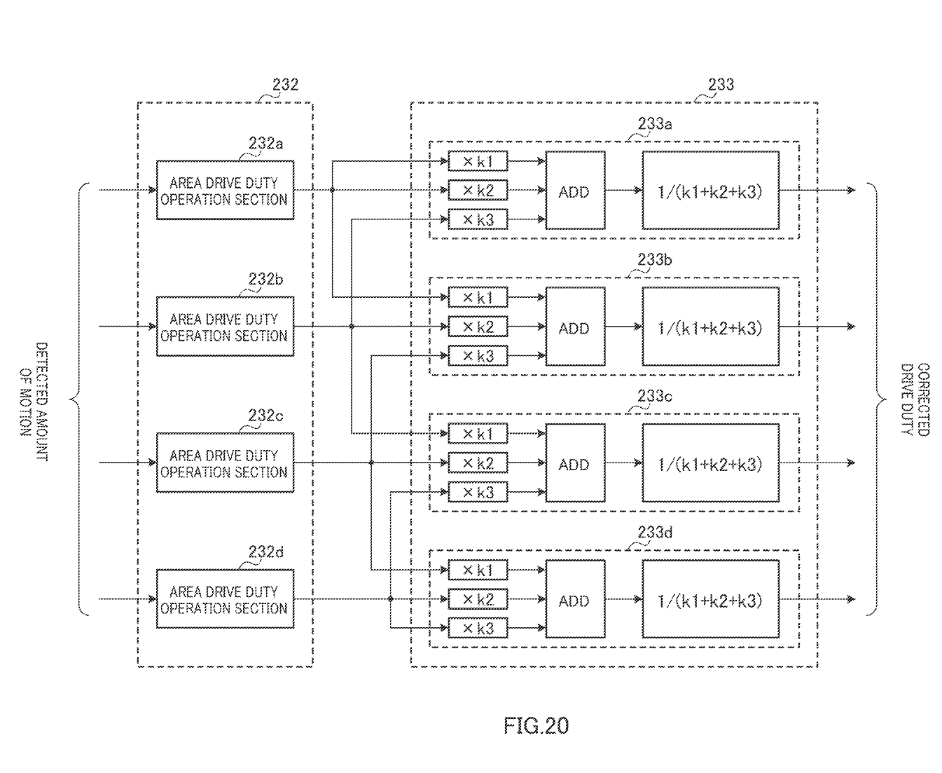

FIG. 18 shows an example for comparison with the drive pulses shown in FIG. 17;

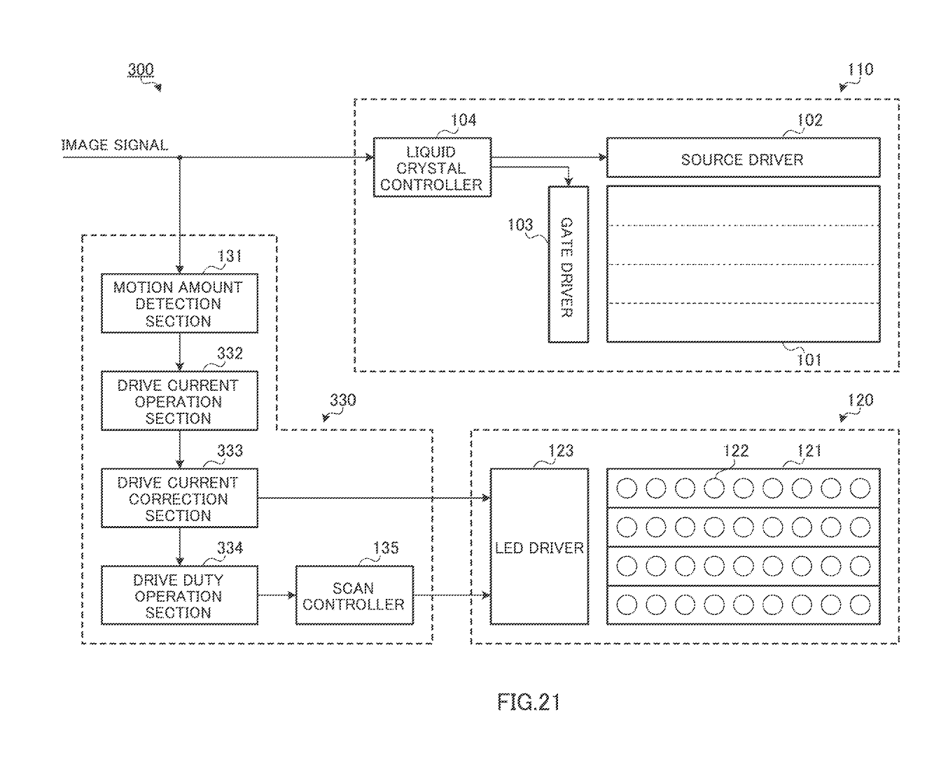

FIG. 19 is a block diagram showing a configuration of a liquid crystal display apparatus according to embodiment 2 of the present invention;

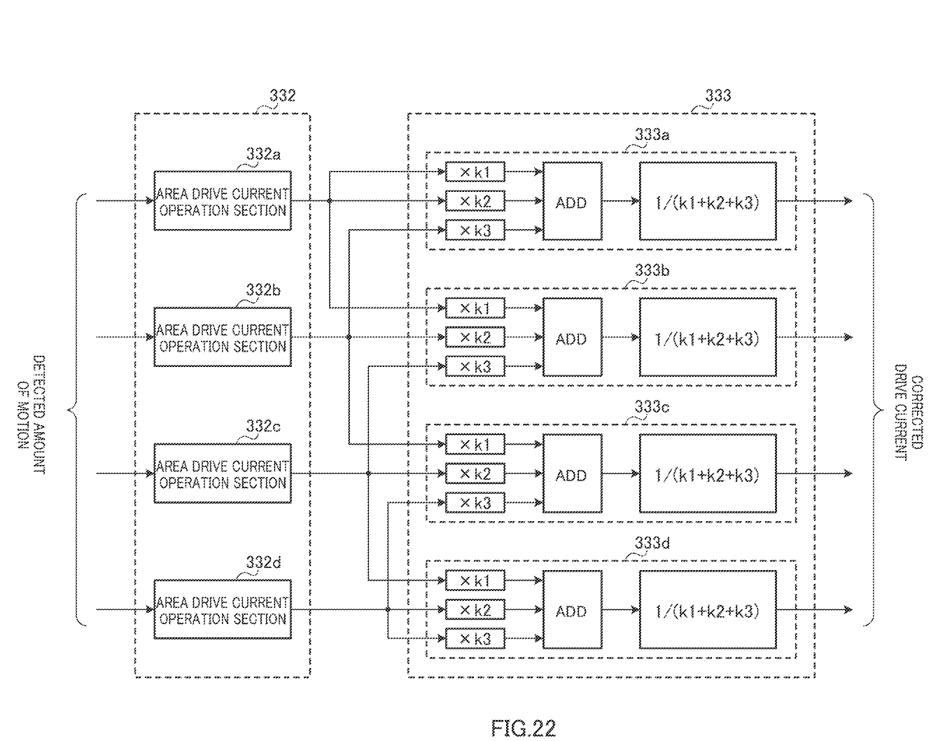

FIG. 20 is a block diagram showing configurations of a drive duty operation section and a drive duty correction section according to embodiment 2 of the present invention;

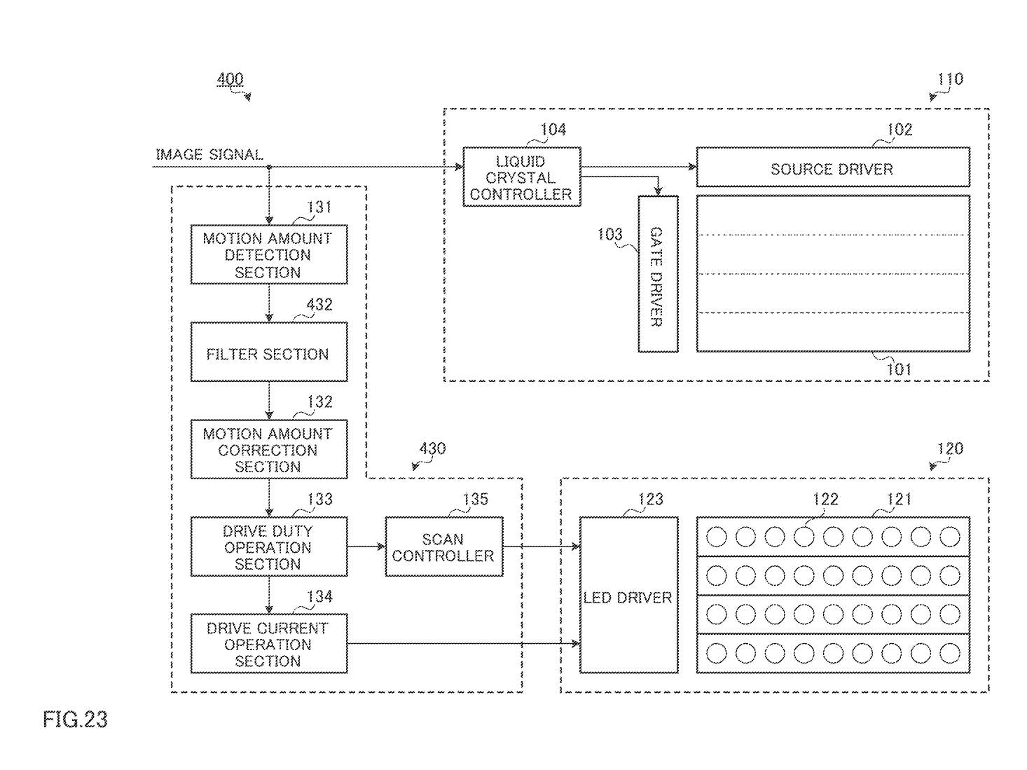

FIG. 21 is a block diagram showing a configuration of a liquid crystal apparatus according to embodiment 3 of the present invention;

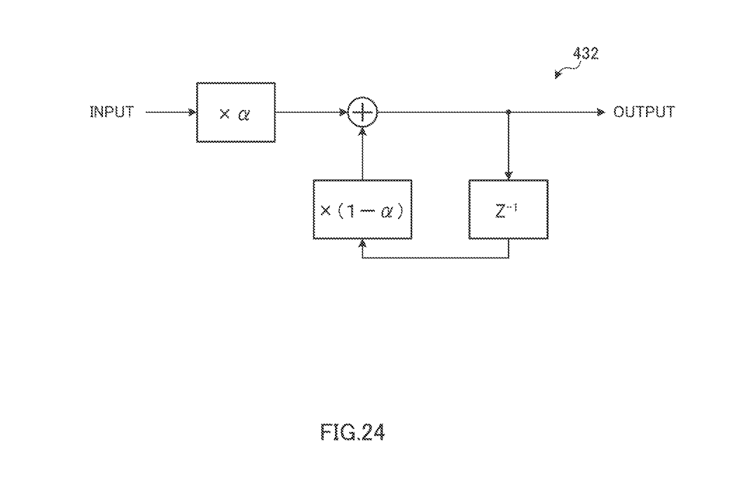

FIG. 22 is a block diagram showing configurations of a drive current operation section and a drive current correction section according to embodiment 3 of the present invention;

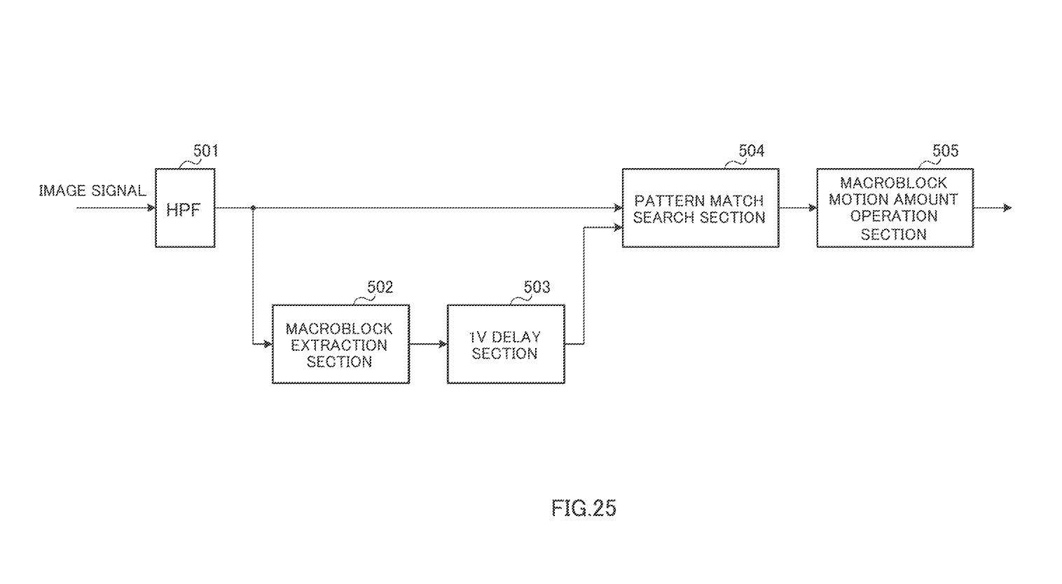

FIG. 23 is a block diagram showing a configuration of a liquid crystal display apparatus according to embodiment 4 of the present invention;

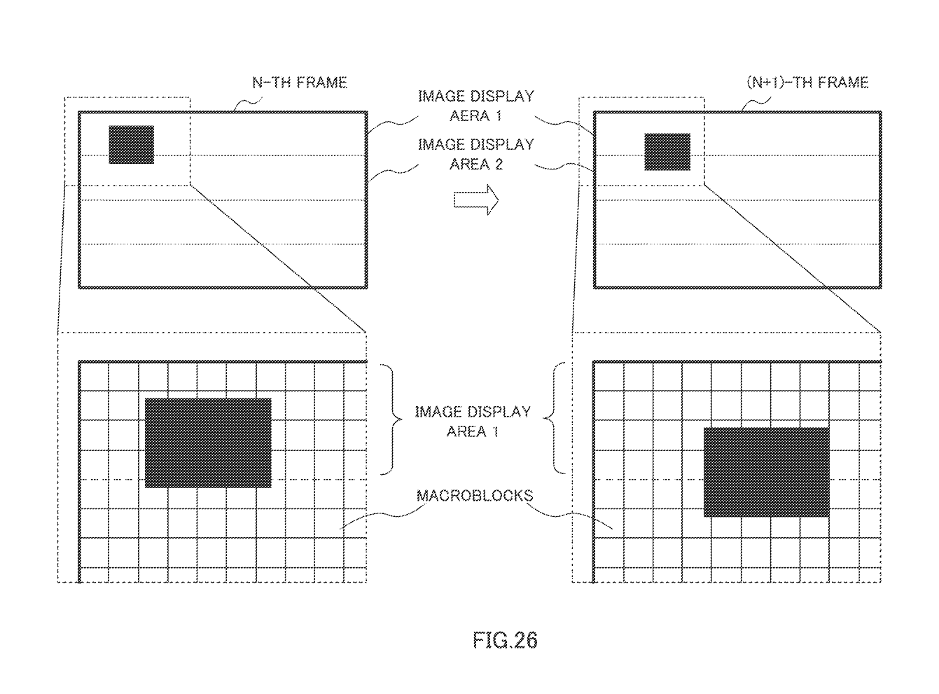

FIG. 24 is a block diagram showing an example of an internal configuration of a filter section according to embodiment 4 of the present invention;

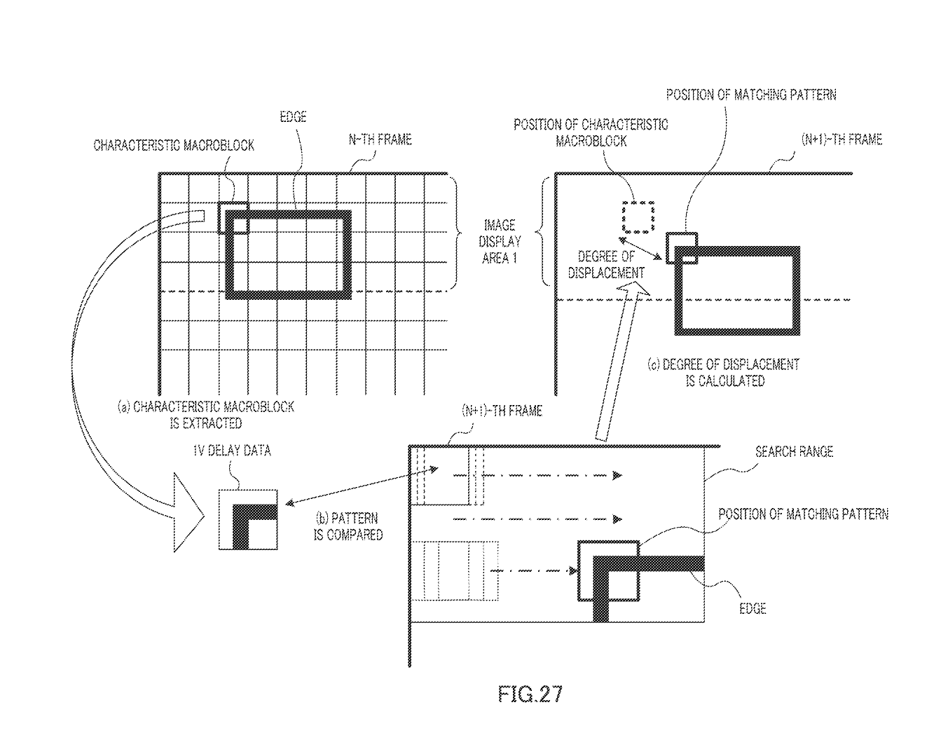

FIG. 25 is a block diagram showing a variation of a configuration of an area motion amount detection section according to embodiment 4 of the present invention;

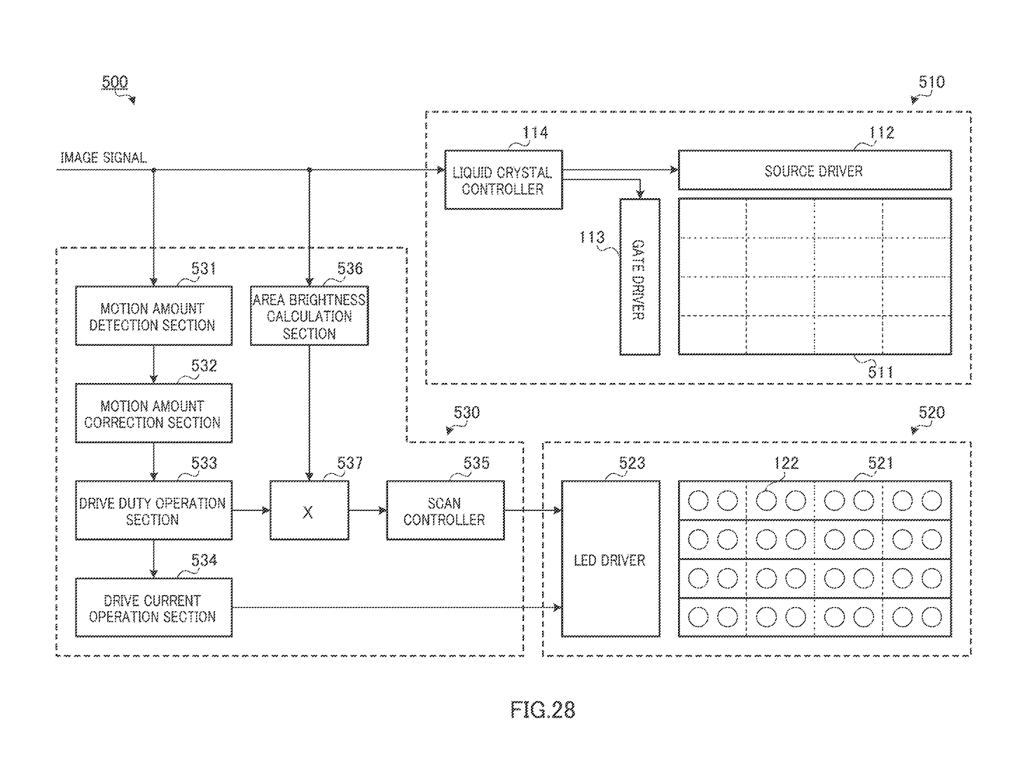

FIG. 26 shows an example of a movie subject to motion amount detection in the area motion amount detection section shown in FIG. 25;

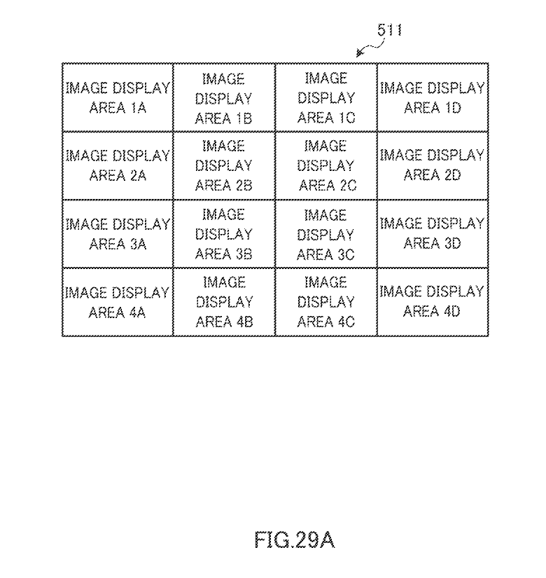

FIG. 27 shows an operation of motion amount detection in the area motion amount detection section shown in FIG. 25;

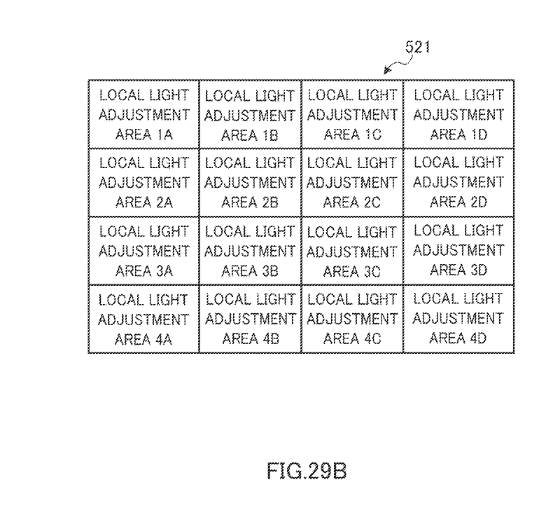

FIG. 28 is a block diagram showing a configuration of a liquid crystal display apparatus according to embodiment 5 of the present invention;

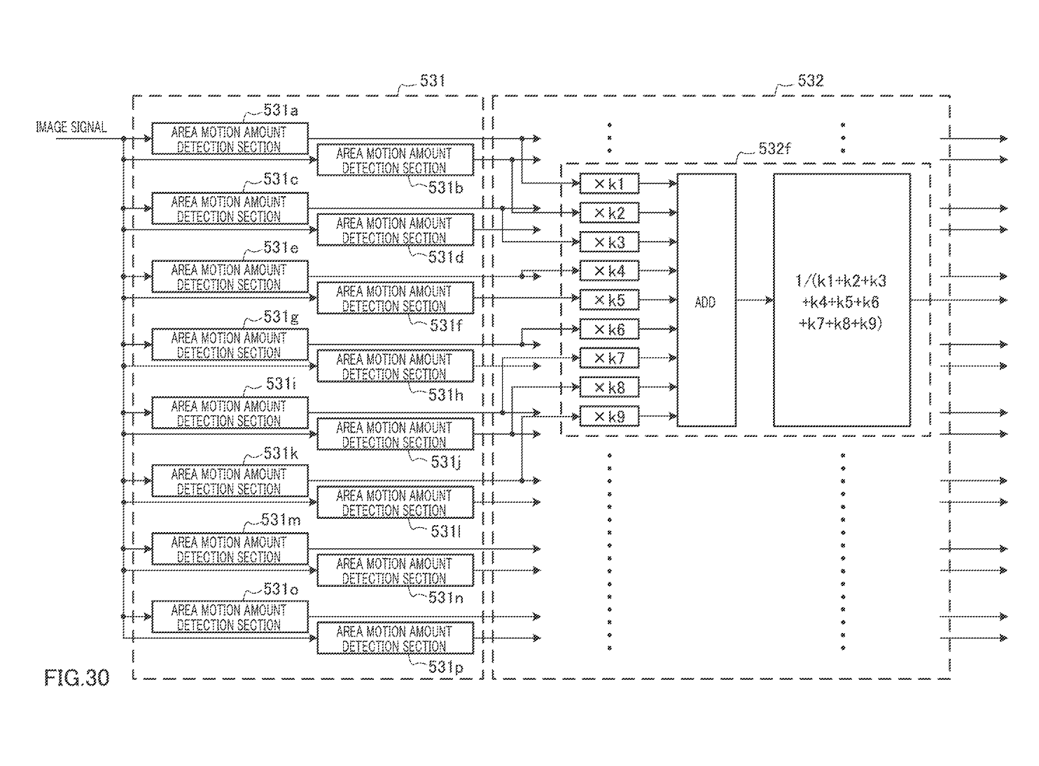

FIG. 29A shows an image display area on a liquid crystal panel according to embodiment 5 of the present invention;

FIG. 29B shows a local light adjustment area in a light emitting section according to embodiment 5 of the present invention;

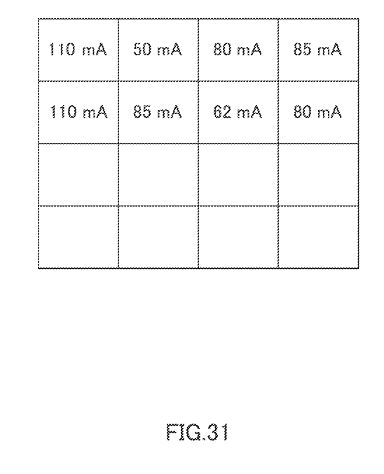

FIG. 30 is a block diagram showing configurations of a motion amount detection section and a motion amount correction section according to embodiment 5 of the present invention;

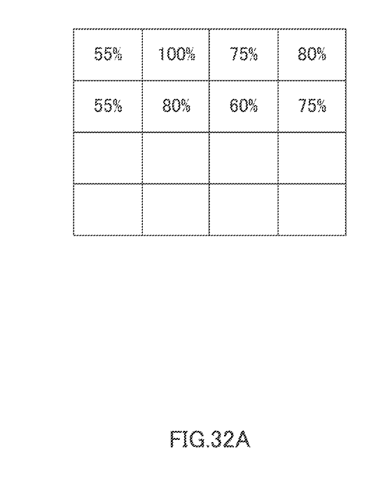

FIG. 31 shows an example of output of a drive current operation section according to embodiment 1 of the present invention;

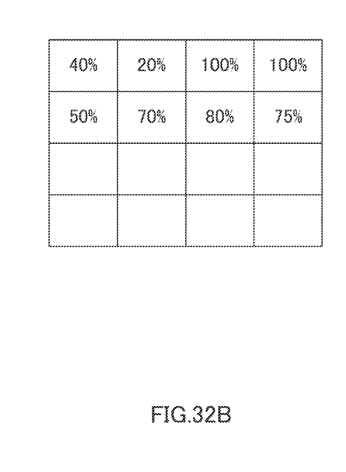

FIG. 32A shows an example of output of a drive duty operation section according to embodiment 5 of the present invention;

FIG. 32B shows an example of output of an area brightness calculation section according to embodiment 5 of the present invention;

FIG. 32C shows an example of output of an area light adjustment section according to embodiment 5 of the present invention;

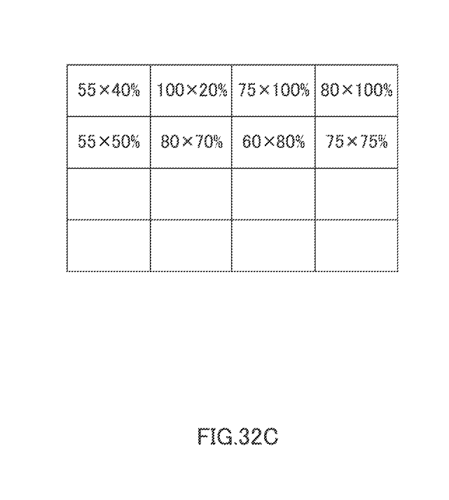

FIG. 33 shows examples of drive pulses per local light emitting area according to embodiment 5 of the present invention;

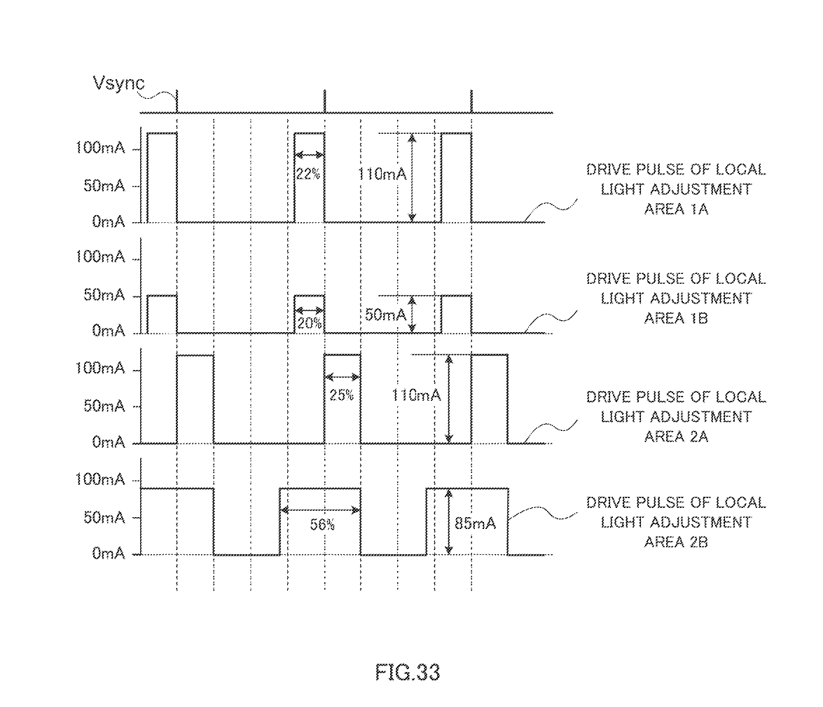

FIG. 34A is a block diagram showing a variation of a motion amount detection section according to embodiment 5 of the present invention;

FIG. 34B shows an operation of an operation of the motion amount detection section shown in FIG. 34A; and

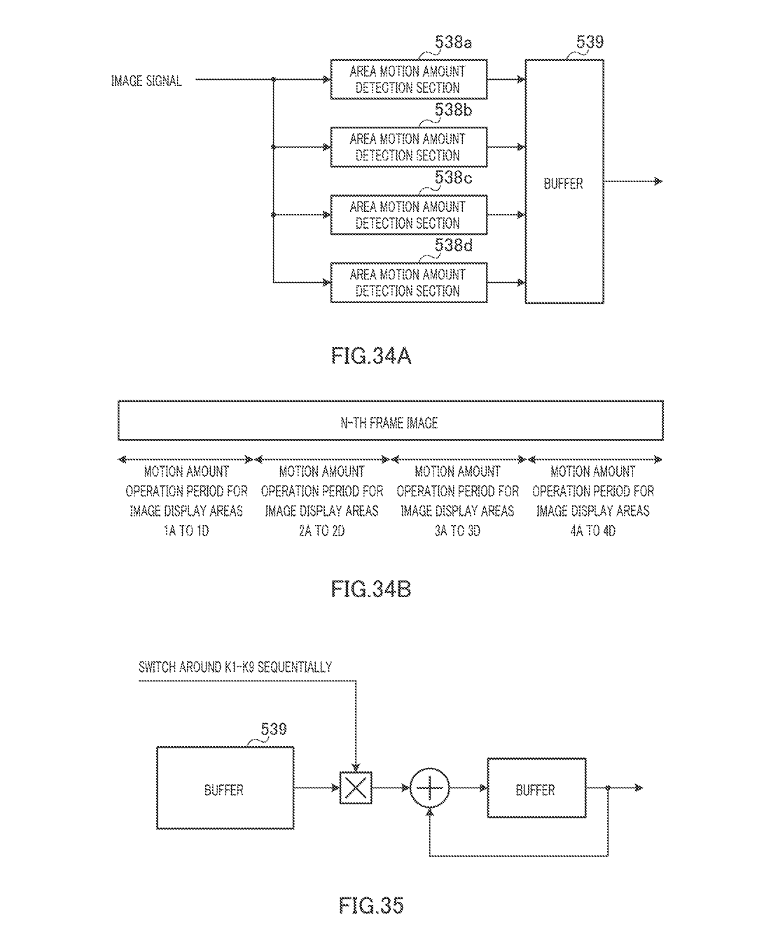

FIG. 35 is a block diagram showing a configuration of a motion amount correction section according to embodiment 5 of the present invention.

### BRIEF DESCRIPTION OF DRAWINGS

Now, embodiments of the present invention will be described below in detail.

### Embodiment 1

Embodiment 1 of the present invention will be described below.

A case will be described with the present embodiment where the amount of motion of an image is corrected per image display area for adjustment of drive conditions per scan area.

<1-1. Configuration of Liquid Crystal Display Apparatus>

The configuration of a liquid crystal display apparatus will be described first. FIG. 5 is a block diagram showing a configuration of a liquid crystal display apparatus according to the present embodiment. Liquid crystal display apparatus 100 has liquid crystal panel section 110, illuminating section 120 and drive control section 130. Illuminating section 120 and drive control section 130, combined, constitute a backlight apparatus.

The configuration of each component will be described in detail.

<1-1-1. Liquid Crystal Panel Section>

Liquid crystal panel section 110 has liquid crystal panel 111, source driver 112, gate driver 113 and liquid crystal controller 114.

When an image signal is received as input in liquid crystal panel section 110, a signal voltage is applied to each pixel on liquid crystal panel 111 as a display section, from source driver 112 and gate driver 113, with timing controlled by liquid crystal controller 114. Consequently, liquid crystal panel 111 is able to modulate the illuminating light emitted from the back of liquid crystal panel 111 according to image signals, and, by this means, allows an image formed with a plurality of pixels to be displayed on a screen. That is to say, liquid crystal panel section 110 forms an optical modulation section.

Now, in FIG. 5, the screen of liquid crystal panel 111 is divided by broken lines, and this means that liquid crystal panel 111 has a plurality of image display areas (four in FIG. 5), not that liquid crystal panel 111 is structurally divided or these lines are actually displayed in an image. The same applies to the other drawings.

Note that liquid crystal panel 111 is able to adopt an IPS (In Plane Switching) scheme, VA (Vertical Alignment) scheme, and so on, but these are by no means limiting.

<1-1-2. Illuminating Section>

Illuminating section 120 emits illuminating light for displaying an image on liquid crystal panel 111 and emits illuminating light on liquid crystal panel 111 from the back side of liquid crystal panel 111.

Illuminating section 120 has light emitting section 121. Light emitting section 121 adopts a direct-type configuration and is formed by placing a large number of point light sources on the back of a diffusion plate in a planar arrangement, so that light is emitted toward the diffusion plate. By this means, light emitting section 121 outputs, from its front surface side, light that is emitted from a light source and is incident from the back.

The present embodiment uses LEDs 122 as point light sources. LEDs 122 all emit white light, and are configured to emit light at the same brightness if driven by the same drive conditions. Note that each LED 122 emits white light by itself or may be configured to emit white light by mixing RGB lights.

Also note that elements other than LEDs may be used as point light sources, or elements that emit light other than white light may be used as well.

Now, in FIG. 5, the light output surface of light emitting section 121 is divided by broken lines, and this means that light emitting section 121 has a plurality of image display areas (five in FIG. 1), not that light emitting section 121 is structurally divided. The same applies to other drawings as well.

Illuminating section 120 has LED driver 123 as a drive section to drive LEDs 122. LED driver 123 has the same number of scan areas so that each scan area can be driven separately.

FIG. 6 shows an example of LED drivers 123. LED driver 123 has: constant current circuit 141 that supplies current to a plurality of serially-connected LEDs 122; communication interface (I/F)142 that receives current value data, which represents the peak value to report to constant current circuit 141, from drive control section 130, via a communication terminal; a digital-to-analog converter (DAC) 143 that converts current value data into a current command signal, which is an analog signal; and switch 144 that allows or blocks input of a current command signal from DAC 143 to constant current circuit 141, according to ON/OFF signals provided from drive control section 130 via ON/OFF terminals. That is to say, LED driver 123 is configured such that a current proportional to the signal voltage of a current command signal is supplied from constant current circuit 141 to LED 122 when switch 144 is turned on and this current supply is blocked when switch 144 is turned off. This configuration is provided per scan area.

With the above configuration, LED driver 123 is able to make a plurality of scan areas to be driven individually and emit light by the same drive conditions including the duties (i.e. ON duties) and peak values of drive pulses designated individually on a per scan area basis.

Note that it is equally possible to use areas which divide scan areas even smaller, as individual drive units, instead of using scan areas as individual drive units. In this case, the configuration shown in FIG. 6 needs to be provided per area of smaller division, and still it is possible to make a plurality of scan areas 3333 to be driven and emit light individually.

<1-1-3. Drive Control Section>

Drive control section 130 is an operation processing apparatus having motion amount detection section 131, motion amount correction section 132, drive duty operation section 133, drive current operation section 134 and scan controller 135, and controls drive conditions including the duties and peak values of drive pulses on a per scan area basis based on an input image signal in each image display area. In drive control section 130, motion amount correction section 132, drive duty operation section 133, drive current operation section 134 and scan controller 135, combined, constitute a drive condition designating section which designate drive conditions on a per scan area basis.

<1-1-3-1. Motion Amount Detection Section>

Motion amount detection section 131, as a motion detection section, detects the amount of motion in an image based on an input image signal. Motion amount detection section 131 has area motion amount detection sections 131a, 131b, 131c and 131d which equal the scan areas in number (consequently equaling the image display areas in number as well).

Area motion amount detection section 131a detects the amount of motion in the image of image display area 1, area motion amount detection section 131b detects the amount of motion in the image of image display area 2, area motion amount detection section 131c detects the amount of motion in the image of image display area 3, and area motion amount detection section 131d detects the amount of motion in the image of image display area 4.

As for the method of detecting the amount of motion, there is, for example, a method of determining the amount of motion by performing pattern-matching of all macroblocks with the previous frame, in macroblock units. Here, macroblocks are individual areas that are defined by dividing image display areas smaller. FIG. 8 shows macroblocks in image display area 2 of liquid crystal panel 111. Note that, as a simpler method of motion detection, there is a method of using the scale of difference of an image signal from the previous frame in the same pixel position.

With the present embodiment, motion amount detection section 131 is configured to output the maximum value of the amounts of motion of macro blocks determined by the former method. That is to say, if the maximum value of the amount of motion is the same between a case where an image over all individual image display areas and a case where an image moves only in part, the same value is output.

FIG. 9 shows the configurations of area motion amount detection sections 131a to 131d. Area motion amount detection sections 131a to 131d each have 1 V delay section 151 that delays an input image signal by one frame, macroblock motion amount operation section 152 that operates the amount of motion in an image per macroblock with reference to the image signal of the previous frame, and maximum value calculation section 153 that calculates the maximum value in the amounts of motion operated.

In the above configuration, motion amount detection section 131 detects the amount of motion of image per image display area.

<1-1-3-2. Motion Amount Correction Section>

Motion amount correction section 132 corrects the amount of motion of an image per image display area for adjustment of drive conditions per scan area. Motion amount correction section 132 has weighted addition sections 132a, 132b, 132c and 132d which equal the scan areas in number.

Weighted addition section 132a corrects the amount of motion detected in image display area 1, weighted addition section 132b corrects the amount of motion detected in image display area 2, weighted addition section 132c corrects the amount of motion detected in image display area 3, and weighted addition section 132d corrects the amount of motion detected in image display area 4.

Weighted addition sections 132a to 132d assigns weights to the amount of motion detected in an upper image display area neighboring a target image display area, the amount of motion detected in the target image display area, and the amount of motion detected in a lower image display area neighboring the target image display area, using coefficients k1, k2 and k3, adds up the weighted values, and calculates a corrected amount of motion for the target image display area by dividing that sum by the sum of k1, k2 and k3 so that the sum of coefficients k1, k2 and k3 is normalized to 1, and outputs this result.

The above configuration makes it possible to take into account the influence of the amount of motion in surrounding image display areas upon determining the amount of motion in each image display area which serves as the basis of the drive conditions of each scan area.

Note that coefficients k1, k2 and k3 are either fixed values or variable values.

Furthermore, with the present embodiment, the target image display area for weighted addition section 132a is located in the highest position, so that weighted addition section 132a uses the amount of motion detected in that target image display area as the amount of motion detected in the upper image display area as well. Likewise, the target image display area for weighted addition section 132d is located in the lowest position, so that weighted addition section 132d uses the amount of motion detected in that target image display area as the amount of motion detected in the lower image display area as well.

Although with the present embodiment the amount of motion detected only in one image display area is corrected based on the amounts of motion in a plurality of neighboring image display areas, it is equally possible to correct the amounts of motion detected in two or more image display areas.

Furthermore, with the present embodiment, the number of scan areas or image display areas is four, and the number of neighboring image display areas to reference in order to correct a specific detected amount of motion is limited to three, which includes one upper and one lower neighboring image display area. When the number of scan areas or image display areas is greater than four, it is possible to increase the number of neighboring image display areas to reference in order to increase the influence of surrounding areas. For example, as shown in FIG. 10, in the event eight area motion amount detection sections 131a to 131h are provided to match the number of scan areas and image display areas, each weighted addition section (FIG. 10 shows weighted addition section 132d alone for ease of explanation) might reference, for example, five neighboring image display areas in order to correct a specific detected amount of motion.

Furthermore, the algorithm that can be used upon correction of the amount of motion is not limited to the weighted addition described above, and it is equally possible to use different optimization algorithms.

<1-1-3-3. Drive Duty Operation Section>

Drive duty operation section 133 performs an operation for converting a corrected amount of motion output from motion amount correction section 132 into a drive pulse duty value for each scan area. Drive duty operation section 133 determines the drive duty per scan area, based on the corrected amounts of motion acquired on a per image display area basis.

Here, as shown in FIG. 11, the drive duty is set smaller when the amount of motion is bigger or the drive duty is set bigger when the amount of motion is smaller, and the drive duty is set to 100% when the amount of motion is zero. Note that the amount of motion and drive duty are substantially related such that drive duty decreases when the amount of motion increases, and the specific values in FIG. 11 are given simply by way of example and various changes are possible.

<1-1-3-4. Drive Current Operation Section>

Drive current operation section 134 performs an operation for acquiring the peak value of a drive pulse from drive duty output from drive duty operation section 133. That is to say, drive current operation section 134 determines the peak value in each scan area based on the drive duty determined per scan area.

Now, drive current operation section 134 controls the peak values to achieve a predetermined level of brightness regardless of the variation of drive duty values. Consequently, as shown in FIG. 12, for example, drive current operation section 134 has a table showing the relationship between drive duty and peak value to make the brightness a predetermined value, and determines a peak value from drive duty with reference to this table. Note that the amount of motion and drive duty are substantially related such that drive duty decreases when the amount of motion increases, and the specific values in FIG. 11 are given simply by way of example and various changes are possible.

Drive current operation section 134 generates current value data, which is a digital signal to represent the determined peak value, and outputs this to illuminating section 120. By this means, a peak value is designated as a drive condition per scan area.

<1-1-3-5. Scan Controller>

Based on the drive duties determined on a per scan area basis, scan controller 135 generates ON/OFF signals on a per scan area basis, at timing based on a vertical synchronization signal, and outputs the generated ON/OFF signals to illuminating section 120. By this means, a drive duty is designated as a drive condition in every scan area. By this means, when an ON/OFF signal for one scan area is an ON signal, above LED driver 123 makes :hat scan area drive and emit light, or, if that ON/OFF signal is an OFF signal, instead of making that scan area drive and emit light, generates a drive pulse and supplies this drive pulse to LED 122 included in that scan area.

FIG. 13A shows examples of ON/OFF signal waveforms output from scan controller 135. Here, ON/OFF signals that are output when, as shown in FIG. 13B, the drive duties determined on a per scan area basis are all 50% and identical. Image scan is performed in the order of image display area 1, image display area 2, image display area 3 and image display area 4, and backlight scan is also performed in the order of scan area 1, scan area 2, scan area 3 and scan area 4.

In the examples shown in FIG. 13A, the amount of motion is the same in each image display area, so that no difference of movie resolution is produced between these image display areas. Furthermore, the peak value to be required to make the brightness of each scan is the same, so that unevenness in color is not produced between these image display areas.

Also, in the examples shown in FIG. 13A, in the image scan period for each image display area, the timing to turn off the corresponding scan areas is controlled, so that it is possible to improve movie resolution.

FIG. 14A shows other examples of ON/OFF signal waveforms output from scan controller 135. Here, as shown in FIG. 14B, ON/OFF signals that are output when drive duties that are determined on a per drive area basis vary, are shown. As obvious from FIG. 14A, when changing the drive duty of each scan area, only the rising phase in the ON/OFF signal of each scan area is changed, without changing the trailing phase.

In the example shown in FIG. 14A, differences in the amount of motion are produced between image display areas, causing differences in the resolution of movie between these image display areas. Furthermore, upon trying to make the brightness of each scan area the same, still, the peak value varies between scan areas and unevenness in color is produced between image display areas. The present embodiment is able to improve these deficiencies, and specific operations to realize that will be described later.

The configuration of liquid crystal display apparatus 100 has been described.

<1-2. Operation of Liquid Crystal Display Apparatus>

Next, operations to be executed by liquid crystal display apparatus 100 as a whole (that is, overall operations)—mainly the characteristic operations of the present invention—will be described.

<1-2-1. Overall Operations>

An example of overall operations will be described with reference to FIG. 15, FIG. 16 and FIG. 17.

FIG. 15 shows a sequence of image signals received as input in liquid crystal panel 110. Now, a movie in which a black vertical line on a white background moves laterally ten pixels in one frame period, is used as an example.

In this example, the vertical line stretches over image display areas 3 and 4, but does not reach image display areas 1 and 2. Consequently, between an N-th frame and an (N+1)-th frame, the amounts of motion detected in image display areas 1 and 2 by motion amount detection section 131 are both 0, and likewise the amounts of motion detected in image display areas 3 and 3 by motion amount detection section 131 are both 10. The same applies to the amount of motion between the (N+1)-th frame and an (N+2)-th frame.

Note that, although in this context the amount of motion is represented by the number of pixels, it is equally possible to convert the number of displacing pixels with reference to a conversion table and use the value after the conversion as the amount of motion. It is also possible to use a different unit from pixels as the unit to represent the amount of motion.

FIG. 16 shows the amounts of motion detected per display area in the left and shows corrected amounts of motion per image display area in the right. In this context, assume an example case where weighted addition coefficients k1, k2 and k3 are 1, 2 and 1, respectively.

Consequently, the corrected amount of motion for image display area 1 obtained by motion amount correction section 132 is (0×1+0×2+0×1)/4=0. That is to say, the image in image display area 1 shows no motion and the image below that, in neighboring image display area 2, shows no motion either, so that, even if the amount of motion in neighboring areas is taken into account, the amount of motion in image display area 1 is 0.

Also, the corrected amount of motion for image display area 2 obtained by motion amount correction section 132 is (0×1+0×2+10×1)/4=2.5. That is to say, the image in image display area 2 shows no motion, the image above that, in neighboring image display area 1, shows no motion either, and yet the image below that, in neighboring image display area 3, shows motion of 10 pixels, so that, if the amount of motion in neighboring areas is taken into account, the amount of motion in image display area 2 is 2.5.

The corrected amount of motion for image display area 3 obtained by motion amount correction section 132 is (0×1+10×2+10×1)/4=7.5. That is to say, the image in image display area 3 shows motion of 10 pixels, the image above that, in neighboring image display area 2, shows no motion, and the image below that, in neighboring image display area 4, shows motion of 10 pixels, so that, if the amount of motion in neighboring areas is taken into account, the amount of motion in image display area 3 is 7.5.

The corrected amount of motion for image display area 4 obtained by motion amount correction section 132 is (10×1+10×2+10×1)/4=10. That is to say, the image in image display area 4 shows motion of 10 pixels and the image above that, in neighboring image display area 3, also shows motion of 10 pixels, so that, if the amount of motion in neighboring areas is taken into account, the amount of motion in image display area 4 is 10.

By means of this correction taking into account neighboring areas, it is possible to smoothen steep and abrupt changes in the amount of motion between image display areas.

Now, referring to FIG. 11, according to the relationship between the amount of motion and drive duty shown here, the corrected amount of motion for image display area 1, which is 0, is converted to a drive duty of 100%, the corrected amount of motion for image display area 2, which is 2.5, is converted to a drive duty of 95%, the corrected amount of motion for image display area 3, which is 7.5, is converted to a drive duty of 67%, and the corrected amount of motion for image display area 4, which is 10, is converted to a drive duty of 55%,

It then follows that drive duty operation section 133 determines that the drive duty in scan area 1 corresponding to image display area 1 is 100%, the drive duty in scan area 2 corresponding to image display area 2 is 95%, the drive duty in scan area 3 corresponding to image display area 3 is 67%, and the drive duty in scan area 4 corresponding to image display area 4 is 55%.

Note that, to determine drive duty, the relationship between the amount of motion and drive duty shown in FIG. 11 does not necessarily have to be used.

Furthermore, with reference to FIG. 12, according to the relationship between drive duty and peak value shown herein, a peak value of 50 mA is obtained from a drive duty of 100% in scan area 1, a peak value of 52.5 mA is obtained from a drive duty of 95% in scan area 2, a peak value of 80 mA is obtained from a drive duty of 67% in scan area 3, anda peak value of 110 mA is obtained from a drive duty of 55% in scan area 4.

It then follows that drive current operation section 134 is able to determine that the peak value for scan area 1 is 50 mA, the peak value for scan area 2 is 52.5 mA, the peak value for scan area 3 is 80 mA, and the peak value for scan area 4 is 110 mA.

Note that, to determine peak value, the relationship between the peak values and drive duty shown in FIG. 11 does not necessarily have to be used.

When a drive duty and peak value are determined, drive conditions including these are designated with respect to LED driver 123 from scan controller 135 and drive current operation section 134. In accordance with these drive conditions, LED driver 123 supplies drive pulses such as shown in FIG. 17 to LEDs 122 included in each scan area.

<1-2-2. Effect>

By means of the above operations, as shown in FIG. 15, if a difference in the amount of motion is produced between image display areas, a difference in both drive duty and peak value is also produced between scan areas, as shown in FIG. 17. It then follows that there is a likelihood that variation of resolution in movie, and unevenness in color, are produced between image display areas.

However, in the above operations, the amount of motion in each image display area is corrected taking into account the amount of motion in its surrounding areas, so that the difference produced in the amount of motion between neighboring image display areas is reduced.

Consequently, drive conditions are adjusted, and, as a result of this, differences produced between neighboring scan areas with respect to drive conditions are reduced. That is to say, it is possible to prevent both drive duty and peak value included in drive conditions from differing significantly between scan areas. Consequently, it is possible to improve the variation of resolution in movie and unevenness in color and makes these less visible.

Furthermore, in the above operations, differences that are produced in the amount of motion between neighboring image display areas are corrected by way of smoothening.

As for the method of correction, for example, it is possible to cut the amount of motion detected in image display areas, in which there is big motion, by the same proportion. In this case, like the case of smoothening, differences in drive conditions between neighboring scan areas are reduced, but it is still not possible to effectively reduce movie blur in an image display areas of big motion even if flicker can be effectively controlled in image display areas in which there is small motion.

That is to say, by performing correction by way of smoothening, it is possible to prevent various problems such as the above-described deficiencies, and therefore it is possible to reduce both flicker and movie blur.

Note that, when there is no correction of detected amounts of motion, drive pulse waveforms such as the ones shown in FIG. 18 are provided, and differences to equal the peak value are produced. In this case, the light emission chromaticity of LEDs 122 increases between scan areas 2 and 3, and color blur is made visible.

As described above, according to the present embodiment, when a difference is produced between the amounts of motion detected in neighboring image display areas, drive conditions including drive pulse duties and peak values are adjusted such that differences produced in drive conditions between neighboring scan areas are reduced according to the differences in the amount of motion detected. With the present embodiment, this adjustment is carried out by correcting the detected amount of motion. Consequently, when both drive pulse duty and peak value are controlled on a per scan area basis, significant differences in drive conditions are less likely to be produced between neighboring scan areas and it is possible to improve unevenness in color and differences in movie resolution between image display areas.

### Embodiment 2

Embodiment 2 of the present invention will be described below. The liquid crystal display apparatus of the present embodiment has the same basic configuration as the liquid crystal display apparatus of the earlier embodiment. Consequently, parts are the same as in the earlier embodiment or parts that are equivalent to the earlier embodiment will be assigned the same reference numerals without further explanations, and the differences will be mainly explained.

A case will be described with the present embodiment where the drive duty of each scan area is corrected in order to adjust the drive conditions on a per scan area basis.

<2-1. Configuration of Liquid Crystal Display Apparatus>

FIG. 19 shows a configuration of the liquid crystal display apparatus of the present embodiment. Liquid crystal display apparatus 200 has drive control section 230 instead of drive control section 130. Drive control section 230 is an operation processing apparatus having motion amount detection section 131, drive duty operation section 232, drive duty correction section 233, drive current operation section 134 and scan controller 135, and controls drive conditions including drive pulse duty and peak value on a per scan area basis based on an input image signal of each image display area. In drive control section 230, drive duty operation section 232, drive duty correction section 233, drive current operation section 134 and scan controller 135, combined, constitute a drive condition designating section that designates drive conditions on a per scan areas basis.

<2-1-1. Drive Duty Operation Section>

Drive duty operation section 232 performs an operation for converting the amount of motion detected in each image display area, output from motion amount detection section 131, into a drive pulse duty value per scan area. Consequently, drive duty operation section 232 has area drive duty operation section 232a, 232b, 232c and 232d, which equal the scan areas in number as shown in FIG. 20.

Area drive duty operation section 232a determines the drive pulse duty for scan area 1 from the amount of motion detected in image display area 1 output from area motion amount detection section 131a (FIG. 7). Area drive duty operation section 232b determines the drive pulse duty for scan area 2 from the amount of motion detected in image display area 2 output from area motion amount detection section 131b (FIG. 7). Area drive duty operation section 232c determines the drive pulse duty for scan area 3 from the amount of motion detected in image display area 3 output from area motion amount detection section 131c (FIG. 7). Area drive duty operation section 232d determines the drive pulse duty for scan area 4 from the amount of motion detected in image display area 4 output from area motion amount detection section 131d (FIG. 7).

Now, as shown in FIG. 11, drive duty is set smaller when the amount of motion is bigger, drive duty is set bigger when the amount of motion is smaller, and drive duty is set to 100% (that is, in the event of a still image) when the amount of duty is set to zero. Note that the amount of motion and drive duty are substantially related such that drive duty decreases when the amount of motion increases, and the specific values in FIG. 11 are given simply by way of example and various changes are possible.

<2-1-2. Drive Duty Correction Section>

Drive duty correction section 233 corrects the drive duties determined per scan area, in order to adjust the drive conditions on a per scan area basis. Drive duty correction section 233 has weighted addition sections 233a, 233b, 233c and 233d, which equal the scan areas in number, as shown in FIG. 20.

Weighted addition section 233a corrects the determined drive duty in scan area 1, weighted addition section 233b corrects the determined drive duty in scan area 2, weighted addition section 233c corrects the determined drive duty in scan area 3, and weighted addition section 233d corrects the determined drive duty in scan area 4.

Weighted addition sections 233a to 233d assign weights to the drive duty determined in the upper neighboring scan area of the target scan area, the drive duty determined in the target scan area, and the drive duty determined in the lower neighboring scan area of the target scan area, using coefficients k1, k2 and k3, adds up the weighted values, and calculates a corrected drive duty for the target scan area by dividing that sum by the sum of k1, k2 and k3 so that the sum of coefficients k1, k2 and k3 is normalized to 1, and outputs this result.

The above configuration makes it possible to take into account the influence of the amount of motion in surrounding image display areas upon determining drive duty, which is one drive conditions in each scan area.

Furthermore, with the present embodiment, the target scan area for weighted addition section 233a is located in the highest position, so that weighted addition section 233a uses the drive duty determined in that target scan area as the drive duty determined in the upper scan area as well. Likewise, the target scan area for weighted addition section 233d is located in the lowest position, so that weighted addition section 233d uses the drive duty determined in that target scan area as the drive duty determined in the lower scan area as well.

Although with the present embodiment the drive duty determined only in one scan area is corrected based on the drive duties in a plurality of neighboring scan areas, it is equally possible to correct the drive duties determined in two or more scan areas.

Furthermore, with the present embodiment, the number of scan areas is four, and the number of neighboring scan areas to reference in order to correct a specific determined drive duty is limited to three, which includes one upper and one lower neighboring scan area. When the number of scan areas is greater than four, it is possible to increase the number of neighboring scan areas to reference in order to increase the influence of surrounding areas.

Furthermore, according to the present embodiment, the algorithm that can be used upon correction of drive duty is not limited to the weighted addition described above, and it is equally possible to use different optimization algorithms.

As described above, according to the present embodiment, when a difference is produced between the amounts of motion detected in neighboring image display areas, drive conditions including drive pulse duties and peak values are adjusted such that differences produced in drive conditions between neighboring scan areas are reduced according to the differences in the amount of motion detected. With the present embodiment, this adjustment is carried out by correcting drive duties in accordance with the amount of duty detected. Consequently, when both drive pulse duty and peak value are controlled on a per scan area basis, significant differences in drive conditions are less likely to be produced between neighboring scan areas and it is possible to improve unevenness in color and differences in movie resolution between image display areas.

### Embodiment 3

Embodiment 3 of the present invention will be described now. The liquid crystal display apparatus of the present embodiment has the same basic configuration as the liquid crystal display apparatus of the earlier embodiment. Consequently, parts are the same as in the earlier embodiment or parts that are equivalent to the earlier embodiment will be assigned the same reference numerals without further explanations, and the differences will be mainly explained.

A case will be described with the present embodiment where the drive current (that is, peak value) of each scan area is corrected in order to adjust the drive conditions on a per scan area basis.

<3-1. Configuration of Liquid Crystal Display Apparatus>

FIG. 21 shows a configuration of a liquid crystal display apparatus according to the present embodiment. Liquid crystal display apparatus 300 has drive control section 330 instead of drive control section 130. Drive control section 330 is an operation processing apparatus having motion amount detection section 131, drive current operation section 332, drive current correction section 333, drive duty operation section 334 and scan controller 135, and controls drive conditions including drive pulse duties and peak values on a per scan area basis based on an input image signal of each image display area. In drive control section 330, drive current operation section 332, drive current correction section 333, drive duty operation section 334 and scan controller 135, combined, constitute a drive condition designating section that designates drive conditions on a per scan area basis.

<3-1-1. Drive Current Operation Section>

Drive duty operation section 332 performs an operation for converting the amount of motion detected in each image display area, output from motion amount detection section 131, into a drive current per scan area. That is to say, as shown in FIG. 22, drive current operation section 332 has drive current operation sections 332a, 332b, 332c, and 332d which equal the scan areas in number.

Area drive current operation section 332a determines the drive current for scan area 1 from the amount of motion detected in image display area 1 output from area motion amount detection section 131a (FIG. 7). Area drive current operation section 332b determines the drive current for scan area 2 from the amount of motion detected in image display area 2 output from area motion amount detection section 131b (FIG. 7). Area drive current operation section 332c determines the drive current for scan area 3 from the amount of motion detected in image display area 3 output from area motion amount detection section 131c (FIG. 7).

Area drive current operation section 332d determines the drive current for scan area 4 from the amount of motion detected in image display area 4 output from area motion amount detection section 131d (FIG. 7).

There arc various methods of determining a drive current from the amount of motion, and the method to use the relationship between the amount of motion and drive current shown in FIG. 11 and FIG. 12 is an example.

<3-1-2. Drive Current Correction Section>

Drive current correction section 333 corrects the drive currents determined per scan area, in order to adjust the drive conditions on a per scan area basis. Drive duty correction section 333 has weighted addition sections 333a, 333b, 333c and 333d, which equal the scan areas in number, as shown in FIG. 22.

Weighted addition section 333a corrects the determined drive duty in scan area 1, weighted addition section 333b corrects the determined drive duty in scan area 2, weighted addition section 333c corrects the determined drive duty in scan area 3, and weighted addition section 333d corrects the determined drive duty in scan area 4.

Weighted addition sections 333a to 333d assign weights to the drive duty determined in the upper neighboring scan area of the target scan area, the drive duty determined in the target scan area, and the drive duty determined in the lower neighboring scan area of the target scan area, using coefficients k1, k2 and k3, adds up the weighted values, and calculates a corrected drive current for the target scan area by dividing that sum by the sum of k1, k2 and k3 so that the sum of coefficients k1, k2 and k3 is normalized to 1, and outputs this result.

The above configuration makes it possible to take into account the influence of the amount of motion in surrounding image display areas upon determining drive current, which is one drive conditions in each scan area.

Furthermore, with the present embodiment, the target scan area for weighted addition section 333a is located in the highest position, so that weighted addition section 333a uses the drive current determined in that target scan area as the drive current determined in the upper scan area as well. Likewise, the target scan area for weighted addition section 333d is located in the lowest position, so that weighted addition section 333d uses the drive current determined in that target scan area as the drive current determined in the lower scan area as well.

Although with the present embodiment the drive current determined only in one scan area is corrected based on the drive currents in a plurality of neighboring scan areas, it is equally possible to correct the drive currents determined in two or more scan areas.

Furthermore, with the present embodiment, the number of scan areas is four, and the number of neighboring scan areas to reference in order to correct a specific determined drive current is limited to three, which includes one upper and one lower neighboring scan area. When the number of scan areas is greater than four, it is possible to increase the number of neighboring scan areas to reference in order to increase the influence of surrounding areas.

Furthermore, according to the present embodiment, the algorithm that can be used upon correction of drive current is not limited to the weighted addition described above, and it is equally possible to use different optimization algorithms.

<3-1-3. Drive Duty Operation Section>

Drive duty operation section 334 performs an operation for converting a corrected amount of motion output from drive current correction section 333 into a drive pulse duty value for each scan area. Drive duty operation section 334 determines the drive duty per scan area, based on the corrected drive currents acquired on a per scan area basis. Upon this determination, for example, the relationship of drive current and drive duty shown in FIG. 12 can be used.

As described above, according to the present embodiment, when a difference is produced between the amounts of motion detected in neighboring image display areas, drive conditions including drive pulse duties and peak values are adjusted such that differences produced in drive conditions between neighboring scan areas are reduced according to the differences in the amount of motion detected. With the present embodiment, this adjustment is carried out by correcting peak values determined based on the detected amount of motion. Consequently, when both drive pulse duty and peak value are controlled on a per scan area basis, significant differences in drive conditions are less likely to be produced between neighboring scan areas and it is possible to improve unevenness in color and differences in movie resolution between image display areas.

### Embodiment 4

Embodiment 4 of the present invention will be described below. The liquid crystal display apparatus of the present embodiment has the same basic configuration as the liquid crystal display apparatus of the earlier embodiment. Consequently, parts are the same as in the earlier embodiment or parts that are equivalent to the earlier embodiment will be assigned the same reference numerals without further explanations, and the differences will be mainly explained.

FIG. 23 shows a configuration of the liquid crystal display apparatus of the present embodiment. Liquid crystal display apparatus 400 has drive control section 430 instead of drive control section 130. Drive control section 430 is an operation processing apparatus having motion amount detection section 131, filter section 432, motion amount correction section 132, drive duty operation section 133, drive current operation section 134 and scan controller 135, and controls drive conditions including drive pulse duty and peak value on a per scan area basis based on an input image signal of each image display area. In drive control section 430, motion amount correction section 132, drive duty operation section 133, drive current operation section 134 and scan controller 135, combined, constitute a drive condition designating section that designates drive conditions on a per scan areas basis.

That is to say, liquid crystal display apparatus 400 adds filter section 432 to liquid crystal display apparatus 100 explained in embodiment 1.

Filter section 432 filters the amount of motion detected in motion amount detection section 131 in order to control flicker due to variation of the amount of motion. Filter section 432 can use, for example, a general IIR (Infinite Impulse Response) filter circuit such as shown in FIG. 24.

When a scene of an input image changes or is complex, a motion amount detection error might occur in motion amount detection section 131. By this means, the amount of motion might vary significantly in a short period of time. Now, the drive conditions including drive duties and peak values vary significantly, in a short period of time, in accordance with the amount of motion. Drive current operation section 134 calculates drive currents such that brightness stays constant even when drive duty changes, but there is a possibility that the same brightness cannot be maintained due to variation of characteristics of LED 122. Human eyes are sensitive to fast variation of brightness, so that even slight variation in brightness is recognized as flicker.

With the present embodiment, time-domain filtering is applied to the detected amount of motion, so that it is possible to prevent the problems such as described earlier.

Note that this configuration to include filter section 432 is applicable to liquid crystal display apparatuses 200 and 300.

Furthermore, with the present embodiment, area motion amount detection section 131a to 131d (FIG. 7) of motion amount detection section 131 may be configured as shown in FIG. 25. This variation will be explained.

In the configuration shown in FIG. 25, motion amount detection sections 131a to 131d each have: a high-pass filter section (HPF) 501 that extracts a characteristic portion image by allowing a high-frequency component of an input image signal; a macroblock extracting section 502 that extracts a characteristic macroblock based on extracted characteristic portion image; 1 V delay section 503 that delays the extracted characteristic macroblock by one frame; pattern-match search section 504 that performs a pattern-match search; and macroblock motion amount operation section 505 that calculates the amount of motion.

Area motion amount detection sections 131a to 131d explained with embodiment 1 determined the amount of motion in all macroblocks and output the maximum value among the respective amounts of motion of macroblocks as a detection value. However, with this configuration, the amount of motion needs to be determined with respect to all macroblocks, and therefore there is unnegligible influence upon circuit scale.

By contrast with this, liquid crystal display apparatus 400 of the present embodiment is provided with motion amount correction section 132 and filter section 432, so that, even if detection of the amount of motion is simplified, slight motion detection error does not directly influence image equality.

Consequently, this variation employs the configuration shown in FIG. 25 and simplifies motion amount detection by determining the amount of motion only with respect to a characteristic macroblock.

Furthermore, movie blur is especially distinct in parts where gradation changes (i.e. edges), and, in this variation, an HPF is applied to an input image signal, so that edge data is acquired as data of characteristic part images and the macroblock where the total of the amount of edges shows the maximum value is extracted as a characteristic macroblock.

Now, the operation of motion amount detection in area motion amount detection section 131a having the configuration shown in FIG. 25 will be described. Here, as shown in FIG. 26, a case will be described where a black square located in the upper left part over image display areas 1 and 2 moves to the lower right diagonally from the N-th frame to the (N+1)-th frame.

As shown in FIG. 27, the macroblock where the total sum of the amounts of edges is the maximum value amongst the macroblocks of image display area 1 is extracts as a characteristic macroblock by macroblock extracting section 502 (step (a)). The edges shown in FIG. 27 are acquired by applying an HPF laterally and vertically. In this example, the total sum of the amounts of edges in the macroblock which is located second from the top and third from the left is the largest, so that this macroblock is extracted as a characteristic macroblock.

The extracted characteristic macroblock is delayed by one frame in 1 V delay section 503 and its pattern is compared against the pattern of the current time (that is, the (n+1)-th frame) in pattern-match search section 504. By this pattern comparison, at the current time, the location having the same pattern as the characteristic macroblock at the current time is specified. Here, as show in the drawing, it is preferable to narrow the range of search to a predetermined size. By narrow the search range, it is possible to further reduce the amount of operation in motion detection.

When the location of the matching pattern is specified, the magnitude of displacement of edge calculated in macroblock motion amount operation section 505 as the amount of motion of image display area 1 (step (c)). By performing a pattern-match search by shifting the area of the macroblock size by one pixel at a time, it is possible to acquire the amount of motion in pixel units.

By this means, according to this variation, a pattern-match search is performed by extracting a characteristic macroblock, so that it is possible to find the amount of motion by relatively simple circuit and practical scale.

The above variation is applicable to the above embodiments.

### Embodiment 5

Embodiment 5 of the present invention will be described in detail. The liquid crystal display apparatus of the present embodiment has the same basic configuration as the liquid crystal display apparatus of the earlier embodiment. Consequently, parts are the same as in the earlier embodiment or parts that are equivalent to the earlier embodiment will be assigned the same reference numerals without further explanations, and the differences will be mainly explained.

The present embodiment, instead of using scan areas as individual drive units, uses local light emitting areas, which divide scan areas even smaller, as individual drive units. Then, a case will be described with the present embodiment where the amount of motion in an image is corrected per corresponding image display area for adjustment of drive conditions of in a plurality of local light emitting areas.

<5-1. Configuration of Liquid Crystal Display Apparatus>

FIG. 28 is a block diagram showing a configuration of a liquid crystal display apparatus according to the present embodiment. Liquid crystal display apparatus 500 has liquid crystal panel section 510, illuminating section 520 and drive control section 530. Illuminating section 520 and drive control section 530, combined, constitute a backlight apparatus.

The configuration of each part will be described in detail.

<5-1-1. Liquid Crystal Panel Section>

Liquid crystal panel section 510 has liquid crystal panel 511 instead of liquid crystal panel 111 of embodiment 1. Liquid crystal panel 511 has image display areas (sixteen image display areas in FIG. 28) which divide the image display areas of liquid crystal panel 111 smaller. The image display areas here are configured as image display area 1A to image display area 4D shown in FIG. 29A.

<5-1-2. Illuminating Section>

Illuminating section 520 emits illuminating light for allowing liquid crystal panel 511 to display images and radiates illuminating light upon liquid crystal panel 511 from the back of liquid crystal panel 511.

Illuminating section 520 has light emitting section 521 instead of light emitting section 121 of embodiment 1. In FIG. 28, light emitting section 521 has a plurality of local light adjustment areas (sixteen of them in FIG. 16). Here, the local light adjustment areas are configured as local light adjustment area 1A to local light adjustment area 4D shown in FIG. 29B, corresponding to image display area 1A to image display area 4D, respectively. Furthermore, local light adjustment areas 1A to 1D belong to the same scan area (scan area 1), local light adjustment areas 2A to 2D belong to the same scan area (scan area 2), local light adjustment areas 3A to 3D belong to the same scan area (scan area 3), and local light adjustment areas 4A to 4D belong to the same scan area (scan area 4).

Furthermore, as a drive section to drive LEDs 122, illuminating section 520 has LED driver 523 instead of LED driver 123 of embodiment 1. LED driver 523 has drive terminals which equal to the local light adjustment areas in number, so as to drive each local light adjustment area individually.

<5-1-3. Drive Control Section>

Drive control section 530 is an operation processing apparatus having motion amount detection section 531, motion amount correction section 532, drive duty operation section 533, drive current operation section 534 and scan controller 535, and controls drive conditions including drive pulse duty and peak value on a per local light adjustment area basis based on an input image signal of each image display area. In drive control section 530, motion amount correction section 532, drive duty operation section 533, drive current operation section 534 and scan controller 535, combined, constitute a drive condition designating section that designates drive conditions per local light adjustment area.

<5-1-3-1. Motion Amount Detection Section>

Motion amount detection section 531, which serves as a motion detection section, detects the amount of motion of an image based on an input image signal. As shown in FIG. 30, motion amount detection section 531 has the same number of area motion amount detection sections 531a to 531p as the local light adjustment areas (and as the image display areas, naturally).

Area motion amount detection section 531a detects the amount of motion in the image of image display area 1A, area motion amount detection section 531b detects the amount of motion in the image of image display area 1B, area motion amount detection section 531c detects the amount of motion in the image of image display area 1C, and area motion amount detection section 531d detects the amount of motion in the image of image display area 1D.

Area motion amount detection section 531e detects the amount of motion in the image of image display area 2A, area motion amount detection section 531f detects the amount of motion in the image of image display area 2B, area motion amount detection section 531g detects the amount of motion in the image of image display area 2C, and area motion amount detection section 531h detects the amount of motion in the image of image display area 2D.

Area motion amount detection section 531i detects the amount of motion in the image of image display area 3A, area motion amount detection section 531j detects the amount of motion in the image of image display area 3B, area motion amount detection section 531k detects the amount of motion in the image of image display area 3C, and area motion amount detection section 531l detects the amount of motion in the image of image display area 3D.

Area motion amount detection section 531m detects the amount of motion in the image of image display area 4A, area motion amount detection section 531n detects the amount of motion in the image of image display area 4B, area motion amount detection section 531o detects the amount of motion in the image of image display area 4C, and area motion amount detection section 531p detects the amount of motion in the image of image display area 4D.

<5-1-3-2. Motion Amount Correction Section>

Motion amount correction section 532 corrects the amount of motion of an image per image display area for adjustment of drive conditions per scan area. Motion amount correction section 532 has weighted addition section 532a to 532p, which equal the local light adjustment areas in number. FIG. 30 shows only weighted addition section 532f, for ease of explanation.

Weighted addition sections 532a to 532d correct the amounts of motion detected in image display areas 1A to 1D, respectively; weighted addition sections 532e to 532h correct the amounts of motion detected in image display areas 2A to 2D, respectively; weighted addition sections 532i to 532l correct the amounts of motion detected in image display areas 3A to 3D, respectively; and weighted addition sections 532m to 532p correct the amounts of motion detected in image display areas 4A to 4D, respectively.

Here, effects of weighted addition section 532a to 532p will be explained using weighted addition section 532f by way of example. Weighted addition section 532f assigns weights to the amounts of motion in a target image display area and eight nearby image display areas, using coefficients k1 to k9, adds up the weighted values, and calculates a corrected amount of motion for the target scan area by dividing that sum by the sum of k1 to k9, so that the sum of coefficients k1 to k9 is normalized to 1, and outputs this result. With weighted addition section 532f, the target image display area is image display area 2B. Consequently, the neighboring image display areas are image display areas 1A, 1B, 1C, 2A, 2C, 3A, 3B and 3C.

The above configuration makes it possible to take into account the influence of the amount of motion in surrounding image display areas upon determining the amount of motion in each image display area, which serves as the basis of drive conditions of local light adjustment areas.

Coefficients k1 to k9 may be fixed value or variable values.

In the image display areas located in the upper and lower edges and in the left and right edges of liquid crystal panel 511, part of their surroundings finds no neighboring image display areas. In this case, a weighted addition section uses the amount of motion detected in a target image display area as an amount of motion detected in neighboring image display areas which do not in fact exist. The configuration of weighted addition sections corresponding to image display areas located in the upper and lower edges and in the left and right edges is by no means limited to this. For example, weighted addition sections may assign weights only to surrounding image areas that are actually present.

Furthermore, although the present embodiment corrects the detected amount of motion only in one image display area among a plurality of neighboring image display areas based on the respective detected amounts of motion in these neighboring image display areas, it is equally possible to correct the amount of motion detected in two or more image display areas.

<5-1-3-3. Drive Duty Operation Section>

Drive duty operation section 533 performs an operation for converting a corrected amount of motion output from motion amount correction section 532 into a drive pulse duty value for each scan area. Drive duty operation section 533 determines the drive duty per local light adjustment area, based on the corrected amounts of motion acquired on a per image display area basis.

<5-1-3-4. Drive Current Operation Section>

Drive current operation section 534 performs an operation for acquiring the peak value of a drive pulse from drive duty output from drive duty operation section 533. That is to say, drive current operation section 534 determines the peak value in each local light adjustment area based on the drive duty determined per local light adjustment area.

Now, drive current operation section 534 controls the peak values to achieve a predetermined level of brightness regardless of the variation of drive duty values.

Drive current operation section 534 generates current value data, which is a digital signal to represent the determined peak value, and outputs this to illuminating section 520. By this means, a peak value is designated as a drive condition per local light adjustment area.

FIG. 31 shows a specific example of output of drive current operation section 534. In this drawing, only the numerical values in the upper two rows of the local light adjustment areas are shown by way of example. For example, in local light adjustment area 1A, a peak value of 120 mA is set as a drive condition.

<5-1-3-5. Area Brightness Calculation Section>

Area brightness calculation section 536 calculates brightness on a per image display area basis based on information about the brightness of each pixel included in an input image signal. That is to say, among the image display areas, area brightness calculation section 536 calculates high brightness in areas where information about high brightness is provided and calculates low brightness in areas where only information about low brightness is provided. Area brightness calculation section 536 calculates the brightness of each image display area based on the maximum value, average value and so on of brightness of in each image display area. Area brightness calculation section 536 calculates the brightness of each image display area in percentage—the maximum brightness being 100% and completely dark display being 0%. Other values may be used as well as long as these are proportional to brightness.

<5-1-3-6. Area Light Adjustment Area>

Area light adjustment section 537 determines the light emission brightness value of each local light adjustment area by multiplying the drive duty of each local light adjustment area determined in drive duty operation section 533 by the brightness of each corresponding image display area calculated in area brightness calculation section 536. That is to say, if the brightness calculated in area brightness calculation section 536 is 100%, area light adjustment section 537 outputs a drive duty as determined in drive duty operation section 533 to scan controller 535, or, if the brightness calculated in area brightness calculation section 536 is lower then 100%, makes a drive duty determined in drive duty operation section 533 in accordance with the proportion, and outputs the result to scan controller 535.

FIG. 32A, FIG. 32B and FIG. 32C illustrate specific examples of output of area light adjustment section 537. In this drawing, only the numerical values in the upper two rows of the image display areas are shown. FIG. 32A shows the drive duties calculated in drive duty operation section 533 on a per local light adjustment area basis. FIG. 32B shows brightness calculated per image display area calculated in area brightness calculation section 536. FIG. 32C shows the drive duties determined per local light adjustment area in area light adjustment section 537. That is to say, for example, in local light adjustment area 1A, a drive duty of 55%×40%=22% is set as a drive condition.

<5-1-3-7. Scan Controller>

Scan controller 535 generates ON/OFF signals on a per local light adjustment area basis, at timings based on a vertical synchronization signal, in accordance with the drive duties determined on a per local light adjustment area basis, and outputs the generated ON/OFF signals to illuminating section 520. Then, in local light adjustment areas belonging to the same scan area, ON/OFF signals are generated such that the rising phase and trailing phase match. By this means, drive duties are designated on a per light emitting area basis as drive conditions.

FIG. 33 shows examples of drive pulses of individual local light emitting areas. Note that, in FIG. 33, drive pulses generated based on the peak values and drive duties shown in FIG. 31 are shown only with respect to local light adjustment areas 1A, 1B, 2A and 2B. As shown in FIG. 33, local light adjustment area 1A is driven with a drive duty of 55%×40%=22% and a peak value of 110 mA. Also, local light adjustment area 1B is driven with a drive duty of 100%×20%=20% and a peak value of 50 mA. Local light adjustment area 1A and local light adjustment area 1B, belonging to scan area 1 together, have matching trailing phases. Also, local light adjustment area 2B is driven with a drive duty of 80%×70%=56% and a peak value of 85 mA. Local light adjustment area 2A and local light adjustment area 2B, belonging to scan area 2 together, have matching trailing phases. The trailing phases of local light adjustment area 2A and local light adjustment area 2B lag behind the trailing phases of local light adjustment area 1A and local light adjustment area 1B. In other local light adjustment areas as well, the drive conditions areas are determined based on the drive duties output from area light adjustment section 537 and the peak values output from drive current operation section 534.

<5-2. Effect>

With the above configuration, differences produced between neighboring light adjustment light emitting areas with respect to drive conditions are reduced even when local light adjustment area units, smaller than scan areas, are adopted. That is to say, it is possible to prevent the drive duties and peak values, included in drive conditions, from varying significantly between local light adjustment areas. Consequently, it is possible to improve the variation of resolution in movie and unevenness in color and make these less visible.

With the present embodiment, light emission brightness is calculated on a per local light adjustment area, making possible local backlight control in accordance with input images. As a result of this, for example, it is possible to increase contrast and lower power consumption.

Note that, although motion amount detection section 531 according to the present embodiment is formed with sixteen area motion amount detection sections 531a to 531p and the amount of motion is calculated for each individual image display area, this is by no means limiting. For example, as shown with FIG. 34A, a configuration to have four area motion amount detection sections 538a to 538d, which equal the number of areas provided row-wise, and have buffer 539, which saves output of all area motion amount detection sections 538a to 538d, is possible. As shown in FIG. 34B, it is equally possible to divide an input image signal corresponding to an N-th frame into four, and detect the amount of motion in each corresponding image display area from a divided input image signal, in area motion amount detection sections 538a to 538d, and find the amount of motion for sixteen image display areas. By this means, it is possible to simplify the circuit configuration.

Furthermore, although with the present embodiment motion amount correction section 532 is formed with sixteen motion amount correction sections 532a to 532p and corrects the amounts of motion in individual image display areas separately, this is by no means limiting. For example, upon using a motion amount detection section such as the one shown in FIG. 34A, it is possible to read buffer 539 and assign weights, sequentially, with respect to the amounts of motion in individual image display areas, as shown in FIG. 35, and correct the amount of motion per image display area by adding the results. By this means, it is possible to simplify the circuit configuration.

Furthermore, although a case has been described with the present embodiment where, like embodiment 1, the amount of motion is corrected per image display area in order to adjust the drive conditions on a per local light emission areas basis, this is by no means limiting. Like embodiment 2 and embodiment 3, it is equally possible to correct drive duties on a per local light adjustment area basis or correct the drive current (that is, peak value) on a per local light adjustment area basis. Furthermore, it is equally possible to add a filter section such as the one shown with embodiment 4.

Note that, in the above embodiments, a scan area and local light adjustment area are each an example of a light emitting area.

Now, embodiments of the present invention have been described. Note that the above descriptions have encompassed preferred embodiments of the present invention only by way of example and by no means limit the scope of the present invention. That is to say, the configurations and operations of apparatuses described with the above embodiments are examples, and it is obviously and certainly possible to make changes, additions, and omissions, in part, within the scope of the present invention.

For example, cases have been described with the above embodiments, by way of example, where the present invention is applied to a liquid crystal display apparatus. However, even if an optical modulation section has a display section that is different from a display section, it is equally possible to employ other configurations insofar as providing a non-self-luminous configuration. That is to say, the present invention is applicable to non-self-luminous display apparatuses other than liquid crystal display apparatuses.

The disclosure of Japanese Patent Application No. 2009-227576, filed on Sep. 30, 2009, including the specification, drawings and abstract, is incorporated herein by reference in its entirety.

### INDUSTRIAL APPLICABILITY

The backlight apparatus and display apparatus of the present invention provide an advantage of improving unevenness in color and variation of resolution in movie when controlling the drive duty and drive current per predetermined light emitting area in a light emitting section, and are therefore useful as a backlight apparatus and display apparatus of a backlight scan scheme.

### REFERENCE SIGNS LISTS

100, 200, 300, 400, 500 Liquid crystal display apparatus
110, 510 Liquid crystal panel section
111, 511 Liquid crystal panel
112 Source driver
113 Gate driver
114 Liquid crystal controller
120, 520 Illuminating section
121, 521 Light emitting section
122 LED
123, 523 LED driver
130, 230, 330, 430, 530 Drive control section
131, 531 Motion amount detection section
131a-131h, 531a-531p, 538a-538d Area motion amount detection section
132, 532 Motion amount correction section
132a-132d, 233a-233d, 333a-333d, 532f Weighted addition section
133, 232, 334, 533 Drive duty operation section
134, 332, 534 Drive current operation section
135, 535 Scan controller
141 Constant current circuit
142 Communication I/F
143 DAC
144 Switch
151, 503 1 V delay section
152, 505 Macroblock motion amount operation section
153 Maximum value calculation section
232a-232d Area drive duty operation section
233 Drive duty correction section
332a-332d Area drive current operation section
333 Drive current correction section
432 Filter section
501 HPF
502 Macroblock extracting section
504 Pattern-match search section
536 Area brightness calculation section
537 Area light adjustment area
539 Buffer

1. A backlight apparatus comprising:
a light emitting section that has a plurality of light emitting areas;
a motion detection section that detects an amount of motion of an image in each of a plurality of image display areas corresponding to the plurality of light emitting areas;
a drive condition designating section that designates drive conditions for allowing each of the plurality of light emitting areas to emit light, based on the amounts of motion detected, with respect to each of the plurality of light emitting areas, the drive conditions including drive pulse duties and peak values; and
a drive section that drives each of the plurality of light emitting areas based on designated drive conditions, wherein, when differences are produced in the detect
ed amounts of motion between neighboring image display areas, the drive condition designating section adjusts the drive conditions so that differences in drive conditions between neighboring light emitting areas are reduced in accordance with the differences between the detected amounts of motion.

2. The backlight apparatus according to claim 1, wherein the drive condition designating section adjusts the drive conditions by smoothening the differences in drive conditions between neighboring light emitting areas in accordance with the differences between the detected amounts of motion.

3. The backlight apparatus according to claim 2, wherein the drive condition designating section corrects the amount of motion detected in at least one image display area among the neighboring image display areas, based on the amounts of motion detected in the neighboring image display areas, and determines the drive conditions with respect to at least one light emitting area corresponding to the at least one image display area based on the corrected amount of motion.

4. The backlight apparatus according to claim 3, wherein the drive condition designating section corrects the amount of motion detected in the at least one image display area by performing weighted addition of the amounts of motion detected in the neighboring image display areas.

5. The backlight apparatus according to claim 2, wherein the drive condition designating section determines duties of drive pulses for allowing the neighboring light emitting areas to emit light, based on the amounts of motion detected in the neighboring image display areas, and corrects the duty determined with respect to at least one light emitting areas among the neighboring light emitting areas, based on the duties determined with respect to the neighboring light emitting areas.

6. The backlight apparatus according to claim 5, wherein the drive condition designating section corrects the duty determined with respect to the at least one light emitting area by performing weighted addition of the duties determined with respect to the neighboring light emitting areas.

7. The backlight apparatus according to claim 5, wherein the drive condition designating section determines a peak value of a drive pulse for allowing the at least one light emitting area to emit light, based on the corrected duty.

8. The backlight apparatus according to claim 2, wherein the drive condition designating section determines peaks values of drive pulses for allowing the neighboring light emitting areas to emit light based on the amounts of motion detected in the neighboring image display areas, and corrects the peak value determined with respect to at least one light emitting area among the neighboring light emitting areas based on the peak values determined with respect to the neighboring light emitting areas.

9. The backlight apparatus according to claim 8, wherein the drive condition designating section corrects the peak value determined with respect to the at least one light emitting area by performing weighted addition of the peak values determined with respect to the neighboring light emitting areas.

10. The backlight apparatus according to claim 1, wherein the drive condition designating section determines a duty of a drive pulse for allowing the at least one light emitting area to emit light based on the corrected peak value.

11. The backlight apparatus according to claim 1, further comprising a filter section that filers a detected amount of motion,
wherein the drive condition designating section designates drive conditions based on the filtered amount of motion.

12. The backlight apparatus according to claim 1, wherein the motion detection section extracts a specific macroblock from a plurality of macroblocks that are provided by dividing one image display area, and detects a magnitude of displacement in a partial image in the extracted specific macroblock as the amount of motion in the one image display area.

13. A display apparatus comprising:
the backlight apparatus of claim 1; and
an optical modulating section that displays an image in the plurality of image display areas by modulating illuminating light from the plurality of light emitting areas according to an image signal.
